(19) United States
(12) Patent Application Publication
(10) Pub. No.: US 2022/0164657 A1
(43) Pub. Date: May 26, 2022

(54) DEEP REINFORCEMENT LEARNING FOR FIELD DEVELOPMENT PLANNING OPTIMIZATION

(71) Applicant: Chevron U.S.A. Inc., San Ramon, CA (US)

(72) Inventors: Jincong HE, Sugar Land, TX (US); Xian-Huan WEN, Houston, TX (US); Meng TANG, Mountain View, CA (US); Chaoshun HU, Houston, TX (US); Shusei TANAKA, Houston, TX (US); Kainan WANG, Sugar Land, TX (US)

(21) Appl. No.: 17/534,076

(22) Filed: Nov. 23, 2021

Related U.S. Application Data
(60) Provisional application No. 63/118,143, filed on Nov. 25, 2020.

(51) Int. Cl. G06N 3/08; G06N 3/04

(52) U.S. Cl. CPC G06N 3/08; G06N 3/0454

(57) ABSTRACT

Embodiments of generating a field development plan for a hydrocarbon field development are provided herein. One embodiment comprises generating a plurality of training reservoir models of varying values of input channels of a reservoir template; normalizing the varying values of the input channels to generate normalized values of the input channels; constructing a policy neural network and a value neural network that project a state represented by the normalized values of the input channels to a field development action and a value of the state respectively; and training the policy neural network and the value neural network using deep reinforcement learning on the plurality of training reservoir models with a reservoir simulator as an environment such that the policy neural network generates a field development plan. A field development plan may be generated for a target reservoir on the reservoir template using the trained policy network and the reservoir simulator.

### CROSS-REFERENCE TO RELATED APPLICATIONS

This application claims benefit of U.S. Provisional Application No. 63/118,143, filed Nov. 25, 2020, which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for generating a field development plan for a hydrocarbon field development.

### BACKGROUND

The optimization of field development plans (FDPs), which includes optimizing well counts, well locations, and the drilling sequence is crucial in reservoir management because it has a strong impact on the economics of the project. Traditional optimization studies are scenario specific, and their solutions do not generalize to new scenarios (e.g., new earth model, new price assumption) that were not seen before.

There exists a need in the area of generating a field development plan for a hydrocarbon field development.

### SUMMARY

In accordance with some embodiments, a method of generating a field development plan for a hydrocarbon field development is disclosed. In one embodiment, the method includes generating a plurality of training reservoir models of varying values of input channels of a reservoir template. The input channels represent geological properties, rock-fluid properties, operational constraints, economic conditions, or any combination thereof. The embodiment further includes normalizing the varying values of the input channels to generate normalized values of the input channels and constructing a policy neural network and a value neural network that project a state represented by the normalized values of the input channels to a field development action and a value of the state respectively. The embodiment further includes training the policy neural network and the value neural network using deep reinforcement learning on the plurality of training reservoir models with a reservoir simulator as an environment such that the policy neural network generates a field development plan comprising well counts, well locations, well type, well sequence, or any combination thereof to improve profitability of a hydrocarbon field development.

In accordance with some embodiments, a system of generating a field development plan for a hydrocarbon field development is disclosed. One embodiment includes one or more physical processors configured by machine-readable instructions to generate a plurality of training reservoir models of varying values of input channels of a reservoir template. The input channels represent geological properties, rock-fluid properties, operational constraints, economic conditions, or any combination thereof. The embodiment further includes one or more physical processors configured by machine-readable instructions to normalize the varying values of the input channels to generate normalized values of the input channels and construct a policy neural network and a value neural network that project a state represented by the normalized values of the input channels to a field development action and a value of the state respectively. The embodiment further includes one or more physical processors configured by machine-readable instructions to train the policy neural network and the value neural network using deep reinforcement learning on the plurality of training reservoir models with a reservoir simulator as an environment such that the policy neural network generates a field development plan comprising well counts, well locations, well type, well sequence, or any combination thereof to improve profitability of a hydrocarbon field development.

In accordance with some embodiments, a method of generating a field development plan for a hydrocarbon field development is disclosed. One embodiment includes obtaining values for input channels according to a reservoir template for a target reservoir. The input channels represent geological properties, rock-fluid properties, operational constraints, economic conditions, or any combination thereof. The method further includes rescaling and normalizing the obtained values for the input channels to generate rescaled and normalized target input values. The embodiment further includes generating a field development plan for the target reservoir on the reservoir template with the rescaled and normalized target input values, a trained policy network, and a reservoir simulator. The embodiment further includes rescaling the generated field development plan to scale of the target reservoir model to generate a final field development plan for the target reservoir. The embodiment further includes outputting, on a graphical user interface, at least a portion of the final field development plan.

In accordance with some embodiments, a system of generating a field development plan for a hydrocarbon field development is disclosed. One embodiment includes one or more physical processors configured by machine-readable instructions to obtain values for input channels according to a reservoir template for a target reservoir. The input channels represent geological properties, rock-fluid properties, operational constraints, economic conditions, or any combination thereof. The embodiment further includes one or more physical processors configured by machine-readable instructions to rescale and normalize the obtained values for the input channels to generate rescaled and normalized target input values. The embodiment further includes one or more physical processors configured by machine-readable instructions to generate a field development plan for the target reservoir on the reservoir template with the rescaled and normalized target input values, a trained policy network, and a reservoir simulator. The embodiment further includes one or more physical processors configured by machine-readable instructions to rescale the generated field development plan to scale of the target reservoir model to generate a final field development plan for the target reservoir. The embodiment further includes one or more physical processors configured by machine-readable instructions to outputting, on a graphical user interface, at least a portion of the final field development plan.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1A illustrates one embodiment of the key elements in Reinforcement Learning (RL).

FIG. 1B illustrates one embodiment of a reservoir template, sometimes referred to as a common reservoir template herein.

FIG. 2A illustrates one embodiment of a method of generating a field development plan for a hydrocarbon field development.

FIG. 2B illustrates another embodiment of a method of generating a field development plan for a hydrocarbon field development.

FIG. 3 illustrates one embodiment of structures of a policy network and value network. ReLU means rectified linear unit in FIG. 3.

FIG. 4 illustrates one embodiment of a structure of a residual block.

FIG. 5 illustrates one embodiment of log-permeability of a reservoir and three well location candidates: A, B, and C.

FIG. 6 illustrates one embodiment of a distribution of input channel values before scaling.

FIG. 7 illustrates one embodiment of a distribution of input channel values after scaling.

FIG. 8 illustrates one embodiment of a high-performance computational structure for training a Deep Reinforcement Learning Artificial Intelligence (DRL AI).

FIG. 9 illustrates one embodiment of key performance indicators during the training process.

FIG. 10 illustrates an example well location and drilling sequence from the AI. On the background are maps of four different input channels after scaling—upper left: ctPV/B; upper right: P at the last timestep; lower left: X transmissibility; lower right: PI.

FIG. 11 illustrates an evolution of economic metrics for the example case.

FIG. 12 illustrates example well location and drilling sequence for the reference agents. On the background are maps of ctPV/B. The title indicates the NPV achieved by the different agents for this particular scenario.

FIG. 13 illustrates one embodiment of benchmarking AI performance with reference agents.

FIG. 14 illustrates AI performance at 54 checkpoints during the training process: dashed line, evaluated on unseen scenarios following statistics of the training scenarios; solid line, evaluated on Field X.

FIG. 15 illustrates NPV for the 54 AI solutions gathered at various stages of training. Predictions from the simplified template model are on the x-axis, while predictions from the full-physics 3D model are on the y-axis.

FIG. 16 illustrates one embodiment of a system of generating a field development plan for a hydrocarbon field development.

Like reference numerals refer to corresponding parts throughout the drawings.

### DETAILED DESCRIPTION OF EMBODIMENTS

Oil and gas FDP optimization (such as the optimization of the well count, well location, drilling sequence) can be challenging because of the scales of the reservoir model, the complexity in the flow physics, and the high dimensionality of the control space. Historically, this task has been done manually through limited scenario evaluation by experienced reservoir engineers with a reservoir simulation model. More recently, the use of black-box optimization algorithms, such as genetic algorithms and particle swarm optimization (PSO), have become popular. For example, one approach proposed a modified PSO algorithm to optimize well locations and drilling time in addition to well types and well controls. Another approach presented a hybrid algorithm that combines differential evolution algorithm with mesh adaptive direct search algorithm for optimization of mature reservoirs considering well type conversion (e.g., injectors to producers).

Most of the prior optimization techniques are scenario specific. A scenario is a set of deterministic values or probabilistic distributions for the optimization problem parameters (the reservoir properties, economics variables, etc.), under the assumption of which the optimization is performed. In general, the solution from a scenario-specific optimization study is only optimal for the scenario under which the optimization is run. When the scenario changes (e.g., considering a different reservoir or different economic assumptions), the solution is no longer optimal and the optimization needs to be rerun. For example, PSO can be applied with thousands of runs to optimize the well count and location for Field A assuming oil price to be uniformly distributed between USD price1 and USD price2. However, if the target asset is changed to Field B, or if the oil price assumption is changed to a range of between USD price3 and USD price4, the solution from the previous study is not optimal anymore, and the PSO study and the thousands of runs it requires need to be repeated. Even studies that consider optimization under uncertainty (also known as robust optimization), are usually scenario specific because their solutions are only optimal under a certain assumption of the distribution of the problem parameters. Once the assumption on the distribution changes, the solution is no longer optimal. In summary, the solution from scenario-specific optimization does not generalize to other scenarios.

The reason that traditional scenario-specific optimization approaches cannot generalize is twofold. First, most black-box optimization algorithms only use the objective function values from the simulation runs and ignore other valuable information, such as the pressure and saturation fields. In addition, black-box optimization algorithms do not learn from the optimization results that they have obtained in the past for other reservoirs. This is unlike a human reservoir engineer who can bring his/her knowledge and experience from fields they worked on in the past to a new field.

Described below are methods, systems, and computer readable storage media that provide a manner of generating a field development plan for a hydrocarbon field development. One embodiment includes generating a plurality of training reservoir models of varying values of input channels of a reservoir template. The input channels represent geological properties, rock-fluid properties, operational constraints, economic conditions, or any combination thereof. The embodiment further includes normalizing the varying values of the input channels to generate normalized values of the input channels and constructing a policy neural network and a value neural network that project a state represented by the normalized values of the input channels to a field development action and a value of the state respectively. The embodiment further includes training the policy neural network and the value neural network using deep reinforcement learning (DRL) on the plurality of training reservoir models with a reservoir simulator as an environment such that the policy neural network generates a field development plan comprising well counts, well locations, well type, well sequence, or any combination thereof to improve profitability of a hydrocarbon field development. Another embodiment includes obtaining values for the input channels according to the reservoir template for a target reservoir; rescaling and normalizing the obtained values for the input channels to generate rescaled and normalized target input values; generating a field development plan for the target reservoir on the reservoir template with the rescaled and normalized target input values, the trained policy network, and the reservoir simulator; and rescaling the generated field development plan to scale of the target reservoir model to generate a final field development plan for the target reservoir. Additionally, the embodiment may include outputting, on a graphical user interface, at least a portion of the final field development plan. As such, DRL may be utilized for generalizable field development optimization. In other words, artificial intelligence (AI) using deep reinforcement learning (DRL) may be utilized to address the generalizable field development optimization problem, in which the AI could provide optimized FDPs in seconds for new scenarios within the range of applicability.

In some embodiments, the problem of field development optimization is formulated as a Markov decision process (MDP) in terms of states, actions, environment, and rewards. The policy function, which is a function that maps the current reservoir state to optimal action aₜ the next step, is represented by a deep convolution neural network (CNN). This policy network is trained using DRL on simulation runs of a large number of different scenarios generated to cover a range of applicability. Once trained, the DRL AI can be applied to obtain optimized FDPs for new scenarios at a minimum computational cost.

Advantageously, the DRL AI can provide optimized FDPs for greenfield primary depletion problems with vertical wells. In one embodiment, this DRL AI is trained on more than 3×10⁶ scenarios with different geological structures, rock and fluid properties, operational constraints, and economic conditions, and thus has a wide range of applicability. After it is trained, the DRL AI yields optimized FDPs for new scenarios within seconds. The solutions from the DRL AI suggest that starting with no reservoir engineering knowledge, the DRL AI has developed the intelligence to place wells at “sweet spots,” maintain proper well spacing and well count, and/or drill early. In a blind test described at EXAMPLE_1 herein, it is demonstrated that the solution from the DRL AI outperforms that from the reference agent, which is an optimized pattern drilling strategy, almost 100% of the time. EXAMPLE_2 herein discusses promising field application of the DRL AI.

Because the DRL AI optimizes a policy rather than a plan for one particular scenario, it can be applied to obtain optimized development plans for different scenarios at a very low computational cost. This is fundamentally different from traditional optimization methods, which not only require thousands of runs for one scenario but also lack the ability to generalize to new scenarios.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

This disclosure relates to generalizable field development optimization, in which the solution is a policy rather than a scenario-specific development plan, such that given any scenario within a certain range of applicability, the policy can be evaluated at minimal cost to obtain an optimal development plan for the given scenario. Generalizable field development optimization is fundamentally different from scenario-specific optimization. It provides reservoir engineers the ability to rapidly update the development plan given any change in the model/problem assumptions.

One promising approach for generalizable field development optimization is reinforcement learning (RL), a family of algorithms in which a computer learns to take “actions” in an “environment” to maximize some notion of “cumulative reward.” DRL uses a multilayer neural network (and thus the word “deep”) to model the mapping from the state of the environment, which can be very high dimensional (such as an image or a 3D reservoir model) to the optimal action. The two key elements of DRL, which are RL and deep neural network, will be discuss further hereinbelow.

The large variety of RL algorithms in the recent literature can be classified as model-based and model-free. In model-based methods, the AI agent has access to a model of the environment, which allows it to predict the consequence of its actions (the subsequent state transitions and rewards). One model-based method is a general AI that can be applied to multiple games with minimum hyperparameter tuning. Specifically, a game tree is established in which each node represents the state of the game board, the edges emitting from a node are the possible actions that can be taken at that state, and the leaf nodes are the next states after taking a certain action. The algorithm uses the Monte Carlo tree search to explore the game tree. The exploration is guided by a deep neural network, which predicts the action probability and value of a given state, to prioritize actions/states that are less visited and higher in value and in probability. The results of these simulated games during exploration are in return used as training samples to update the deep neural network by minimizing a loss function. During the training and evaluation stages, the determination of the next action in a Monte Carlo tree search includes running a large number of simulations. Model-based methods are not considered herein because the model-based nature of the methods means that even after training, in the evaluation phase it still takes a large number of simulations to compute the optimal action.

On the other hand, in model-free RL algorithms, the agent does not require access to a model of the environment to choose an action. It derives the next action based on its current (and potentially past) state but not the predicted future. Model-free RL algorithms can be loosely classified as value-based methods and policy-based methods, which differ primarily on what to learn.

The basic idea of value-based methods is to learn a value function, which is a mapping from the state s and action a to the expected total reward. The most popular value-based method is Q-learning, which tries to learn the optimal action-state function Q*(s,a). This function represents the maximum expected future return given any policy, after seeing some state s and taking certain action a. Once Q*(s,a) is obtained, the optimal action for a given s can be obtained by performing optimization of Q over a. Q-learning algorithms have seen substantial successes. Value-based methods are typically “off-policy” methods, which means that the value network can be trained using any samples collected regardless of the policy used to generate the samples.

The idea of policy-based methods is to directly learn the policy in terms of the policy function π(s|θ), which is a mapping from the current state s to action a, parameterized by θ. In the DRL setting, π(s|θ) is represented by a deep neural network, which will be trained by minimizing a loss function. Different recipes for the loss function give birth to different policy-based methods. With a few exceptions (which will be discussed in further herein), policy-based methods are typically “on-policy” methods, which means that the policy network can only be updated using samples collected using the current policy. Notable policy-based methods include the traditional policy gradient method, as well as the various actor/critic methods, such as asynchronous advantage actor/critic, trust region policy optimization, and the proximal policy optimization (PPO; Schulman, J., Wolski, F., Dhariwal, P. et al. 2017. Proximal Policy Optimization Algorithms. available at https://arxiv.org/abs/1707.06347, which is incorporated by reference). In these methods, neural networks are used to model both the policy function and the value function. The agent takes actions according to the policy function, while the goodness of the actions taken is measured against the value function. Because the ultimate goal from RL is the optimal policy rather than the value function, policy-based methods are more direct and appear more stable than value-based methods. On the other hand, the “on-policy” nature of the policy-based methods makes it less sample-efficient compared to the “off-policy” value-based methods.

In the modern application of RL, the policy function and/or the value function are usually modeled by a deep neural network to reflect the complex interaction and nonlinearity in the system. The training of these deep neural networks has been made possible through the numerous recent advancements in the area of deep learning, which is essentially about solving massive optimization problems to fit models with a large number of parameters to a large amount of data. The success in deep learning in recent years has benefited from advances in three areas.

First, the advent of graphics processing unit technology has significantly sped up the training of deep neural networks. This has enabled the widespread use of complex, specialized network structures such as CNNs, which specialize in processing visual imagery and recurrent neural networks, which specialize in data with temporal dynamics.

Second, many effective treatments have been found to make the neural network more benign to the optimization process. For example, the residual neural network has been shown to effectively alleviate the diminishing-gradient problem for deep neural networks in which the gradient of the loss function to the earlier layers becomes vanishingly small. Batch normalization has been proposed to speed up the learning of network weights by normalizing not only the input but also the values at nodes on the intermediate hidden layers.

Third, the robustness of the optimization algorithms has also been substantially improved. Stochastic gradient descent (SGD) has become a popular method for training deep neural networks. In SGD, instead of taking one step along the computed gradient of the loss on all training samples, multiple steps are taken by computing the gradient of the loss of different random subsets of the training samples. SGD substantially lowers the computational cost for each update and also alleviates the impact of local optima and saddle points. In addition, numerous improvements to SGD, such as momentum, root-mean-squared prop, and adaptive momentum estimation Adam, have been proposed and shown to be effective in resolving oscillation of gradient by smoothing it using different moving average formulas.

While DRL has been a popular topic in computer science, it is relatively new in the field of reservoir engineering. Related work includes using RL without deep neural network as an alternative to traditional optimization algorithms to optimize the steam injection in steam-assisted gravity drainage problems. Similarly, one approach has applied various DRL methods for the optimization of water injector rates in waterflooding problems. It is shown that some DRL methods can converge faster than traditional optimization methods, such as PSO, in some cases. Some approaches used DRL for scenario-specific optimization in which the solution is a development plan that is tied to a specific scenario.

In this disclosure, DRL is used for generalizable field development optimization, to develop an AI that can provide optimized FDPs given any scenario (within a certain range of applicability). As previously discussed, this problem is fundamentally different from traditional scenario-specific optimization methods (including those that use DRL), which not only require thousands of runs for one scenario but also lack the ability to generalize to new scenarios.

In some embodiments herein, the problem of generalizable field development optimization is formulated as an MDP in terms of states, actions, environment, and rewards. The use of DRL for oil- and gas field development optimization then involves two stages: training and test. In the training stage, the computer will make a large number of field development trials on a simulator for different fields to develop an optimal policy. This optimal policy is a mapping from the current reservoir states (including geological structure, rock/fluid property, pressure/saturation distribution) to the optimal field development action (e.g., drilling a new well or lowering the control bottomhole pressure (BHP) of a well). In the test (application) stage, the optimal policy can be applied to obtain the optimal FDP for a new reservoir with only one simulation run.

The attractiveness of DRL is not only in the prospect that it can perform field development optimization with minimal computational cost after it is trained, but it is also in the prospect that it can transfer the learning from previously encountered reservoirs to new reservoirs.

This section focuses on how to formulate the problem of field development optimization in the RL framework: (a) outline the key elements in an RL problem, (b) explore two different ways of defining them for field development optimization, and (c) discuss the concept of a common reservoir template, based on which the RL AI can be applied to real reservoirs that come in different sizes, shapes, and properties.

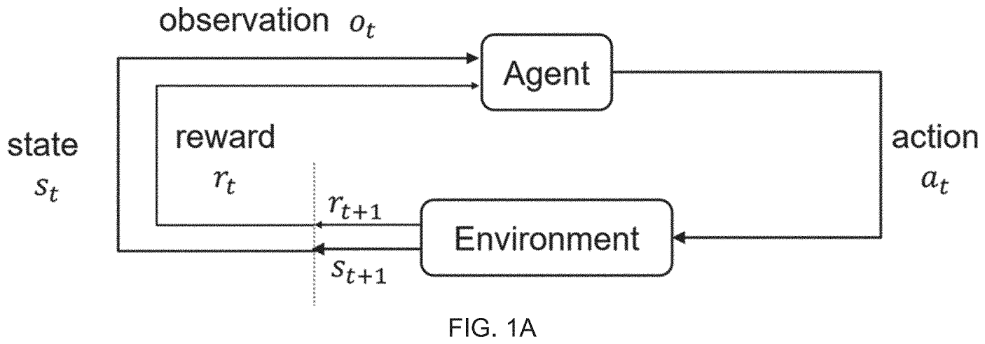

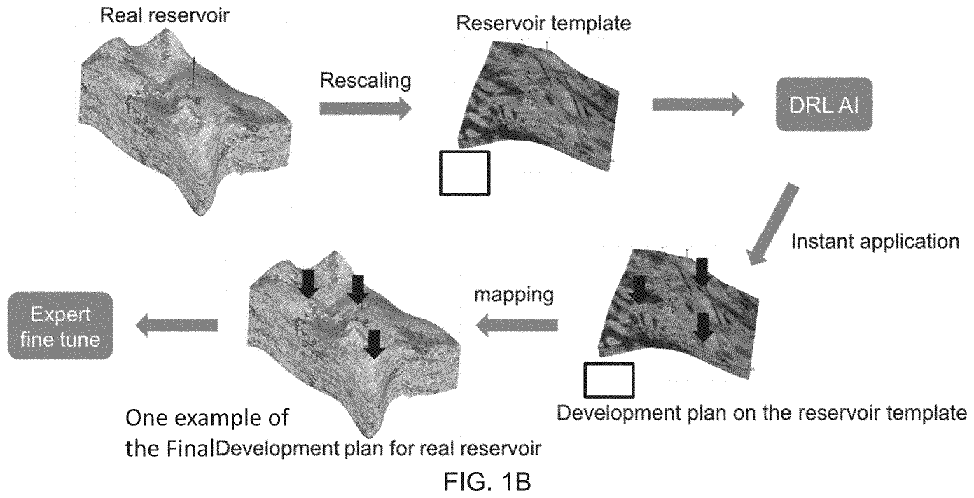

Elements for RL: RL is an area of machine learning in which the goal is to design an AI “agent” that can take actions in an “environment” to maximize a certain objective function called the rewards. As illustrated in FIG. 1A, the two key elements in RL are the environment and the agent.

The environment in RL is typically stated as an MDP. An MDP is a discrete time control process that evolves through time by taking discrete timesteps. At each timestep, the environment starts at a certain state sₜ, the decision maker (referred to as the agent) chooses an action aₜ, and the environment responds by giving a reward rₜ and transit to a new state sₜ₊₁. An assumption in MDP is that given sₜ and aₜ, the reward rₜ, and new state sₜ₊₁ are independent of all previous states prior to the time t (though sₜ₊₁ and aₜ could still be stochastic). This is also called the Markov property. The number of timesteps it takes for the environment to end is called the horizon and is denoted by H.

The agent chooses the action based on the observation oₜ from the environment. The observation or is a function of the current state of the environment sₜ. If the observation contains all the information in sₜ, the MDP environment is called fully observable. Otherwise, it is partially observable. The logic that the agent follows to choose the next action is called a policy. A popular way to formulate the policy function is to write it as a mapping from the current observation or to the probability of taking action aₜ, which can be written as π(aₜ|oₜ,θ), where θ are possible parameters in the policy function.

The goal of RL is to find the optimal policy by optimizing the parameter θ such that the expected cumulative discounted reward can be optimized. Using the preceding notations introduced, the expected cumulative discounted reward R can be expressed as:

$${θ}^{*} = arg {max }_{θ} E \{ {\sum }_{t = 1}^{H} {r}_{t} ( {s}_{t - 1} , {a}_{t - 1} ) \} \qquad Equation 1$$

where the expectation operation is over the stochasticity in the entire system shown in FIG. 1A (definition are provided in FIG. 1A), which could include stochasticity in the initial state of the environment, the policy function and the state transition, and stochasticity (e.g., error) in the observation given the current state.

Generalizable Field Development Optimization as an RL Problem: To formulate the generalizable FDP optimization problem as an RL problem, the environment and the agent are defined.

In model-based FDP optimization, the environment is the reservoir simulator, which solves a set of governing equations to evolve the state. The state of the environment includes static properties that do not change over time, such as geological structure, depth, thickness, and rock and fluid properties. It also includes dynamic properties that change over time, such as pressure and saturation. Besides, it can include operational parameters such as producer drawdown and facility capacity or economic parameters such as oil price and operating cost. At each step, the reservoir simulator processes an action from the agent (e.g., drilling a well at a certain location or not drilling at all) and evolves its dynamic properties. The updated state (static and dynamic) will then be available for observation by the agent. The rewards from the environment would be the discounted cash flow generated through the timestep. The horizon of the environment corresponds to the lives of development projects. Therefore, the cumulative reward from the environment is equivalent to the net present value (NPV) of the project.

The definition of the agent in FDP optimization is more flexible. Two possible options, a rig-based approach or a field-based approach, are provided.

In the rig-based approach, the agent is defined from the perspective of a drilling rig. Then at each timestep, the possible actions for this agent would be to move horizontally in one of the directions (e.g., east, south, west, north) or to drill a well (injector or producer) at a current location to a certain depth. The observation based on which action the agent chooses can be the pressure, saturation, permeability, porosity, etc. around the rig (in this case, the agent would be partially observable). Multiple agents can be used to mimic the coordinated drilling operation of multiple rigs. For example, the training of multiagent systems has been successfully applied for playing a real-time strategy video game.

The advantage of the rig-based approach is that the size of the action space is small, because the agent can only choose to move in a handful of directions or stay still. The computational cost of most RL algorithms scales with the size of the action space, so a small action space is favorable. The drawback of this approach is that given a fixed rig movement step size, it takes multiple action steps for the rig to move to a desirable drilling spot. In other words, the number of action steps to complete a drilling plan is large, resulting in a long horizon. A long horizon can be challenging for RL to train.

An alternative formulation for the agent is a field-based approach. At each timestep, the agent observes the environment state over the entire field and is allowed to select a location in the entire field to drill or not drill at all. The advantage of this formulation is that it minimizes the horizon of the problem. The drawback is that the dimensions of the observation and the action space both scales with the size of the reservoir model. Some embodiments herein will be based on field-based AI.

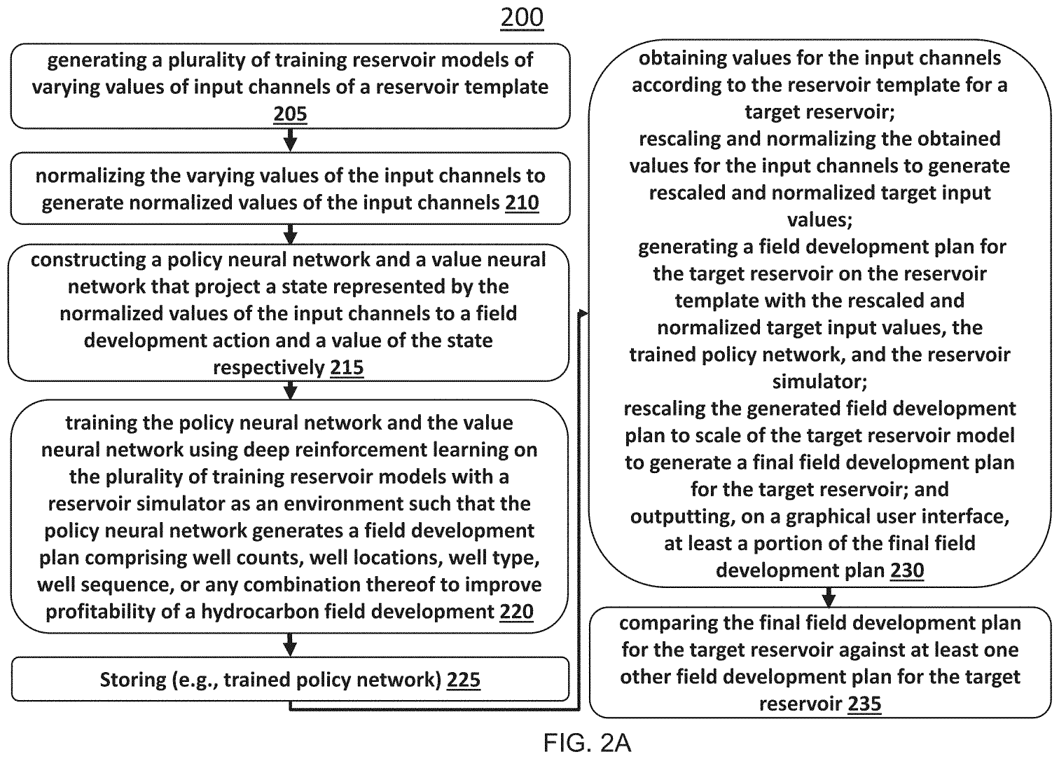

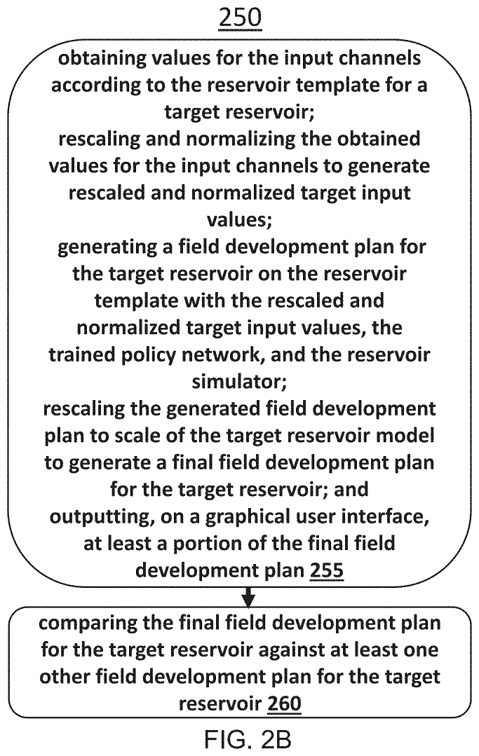

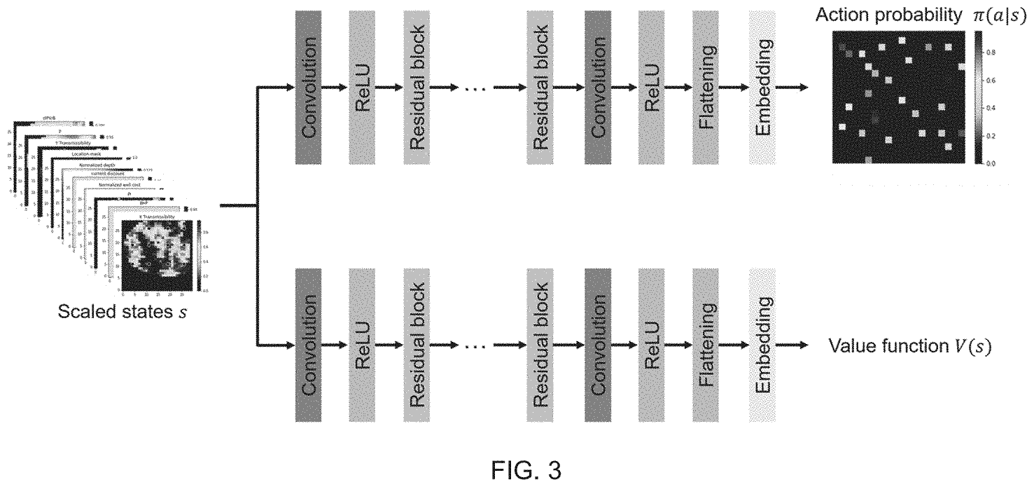

FIG. 2A illustrates an example process 200 generating a field development plan for a hydrocarbon field development that includes training (e.g., training the policy neural network and the value neural network using deep reinforcement learning on the plurality of training reservoir models with a reservoir simulator as an environment such that the policy neural network generates a field development plan) as well as application after training (e.g., generating a field development plan for the target reservoir on the reservoir template with the rescaled and normalized target input values, the trained policy network, and the reservoir simulator and rescaling the generated field development plan to scale of the target reservoir model to generate a final field development plan for the target reservoir). Process 200 may be executed as illustrated in FIGS. 3-7 and 16.

At step 205, the process 200 includes generating a plurality of training reservoir models of varying values of input channels of a reservoir template (sometimes referred to as “common reservoir template” herein). The input channels represent geological properties, rock-fluid properties, operational constraints, economic conditions, or any combination thereof. In some embodiments, the geological properties comprise cell size, depth, thickness, porosity, permeability, active cell indicator, or any combination thereof. In some embodiments, the rock-fluid properties comprise rock and fluid compressibilities, fluid viscosity, fluid formation volume factors, fluid relative-permeabilities, or any combination thereof. In some embodiments, the operational constraints comprise producer draw down, producer skin factor, pre-existing wells, well and field production capacity, or any combination thereof. In some embodiments, the economic conditions comprise cost of drilling a well, operating cost, hydrocarbon price, discount factor, or any combination thereof. In some embodiments, a random number generator is utilized to generate the plurality of training reservoir models of varying values of input channels of the reservoir template based on the predefined range of applicability (e.g., Table 1 provides some examples). In some embodiments, at least one input channel of the reservoir template represents a plurality of properties (e.g., TABLE 2). Some non-limiting embodiments are provided hereinbelow.

Common Reservoir Template: Real reservoirs come in different sizes, shapes, and properties, while AI can only be trained on data following a structured format. For the AI to be able to generalize to different reservoirs, a standard reservoir template is developed on which the DRL AI will be trained. The reservoir template is a specification of the environment state, its format, and ranges as defined in a specific-sized reservoir. FIG. 1B illustrates one embodiment of a common reservoir template.

Problem Formulation for Single-Phase Flow Problem with a 2D Reservoir Template: In this section, the specific problem formulation for single-phase flow problems with a 2D reservoir template is provided.

Governing Equations: The governing equation of 2D single-phase flow problems is a combination of Darcy's law and mass conservation and can be written as Equation 2:

$$\frac{( {c}_{r} + {c}_{j} ) ϕ {S}_{o}}{B} \frac{\partial p}{\partial t} = ∇ ( \frac{k}{μ B} ∇ Ψ ) + q \qquad Equation 2$$

where cᵣ and c_{f} are the rock and fluid compressibilities, respectively, ϕ is the porosity, Sₒ is the oil saturation, p is the pore pressure, k is the permeability, μ is the fluid viscosity, and B is the formation volume factor. The fluid potential Ψ is calculated as Equation 3:

Ψ=p+γₒd Equation 3:

where γₒ is the specific gravity of the fluid, and d is the depth. In Equation 2, q is the sink/source term representing fluid being injected into/produced from the reservoir. It is nonzero only at the locations of the wells and can be calculated as Equation 4:

q=PI(p_{BH}−p) Equation 4:

where P_{BH} is the BHP, and the productivity index PI) is calculated as Equation 5:

$$P I = \frac{2 π kh}{μ B ( ln \frac{{r}_{e}}{{r}_{w}} + S )} \qquad Equation 5$$

where r_{w} is the wellbore radius, and rₑ is the Peaceman's equivalent radius. For the 2D Cartesian grid with isotropic permeability, it depends on the size of the grid and can be approximately calculated as rₑ=0.14\sqrt{Δx²+Δy²}. Equation 2 is usually solved by finite difference methods. Discretizing Equation 2 with finite difference and implicit schemes, leads to Equation 6:

$${[ \frac{( {c}_{r} + {c}_{j} ) ϕ {VS}_{o}}{B} ]}_{i} \frac{{p}_{i}^{n + 1} - {p}_{i}^{n}}{δ t} = {T}_{i + 1 / 2} ( {Ψ}_{i = 1}^{n + 1} - {Ψ}_{i}^{n + 1} ) + {T}_{i - 1 / 2} ( {Ψ}_{i + 1}^{n + 1} - {Ψ}_{i}^{n + 1} ) + {PI}_{i} ( {p}_{BH} - {p}_{i} ) \qquad Equation 6$$

where Tᵢ+½ is the transmissibility between cell i and i+1, and it is defined as Equation 7:

$${T}_{i + 1 / 2} = \frac{{k}_{x} {A}_{x}}{μ B Δ x} , \qquad Equation 7$$

where Aₓ is the cross-sectional area between cell i and i+1. For clarity, only discretization in the x-direction is shown. The discretization in the y-direction is analogous.

Definition of Rewards: The reward at timestep n is calculated as Equation 8:

rⁿ=[(pₒ−cₒₚₑₓ)qⁿ−δⁿc_{capex}]γ^{t} Equation 8:

where pₒ is the price of oil, cₒₚₑₓ is the operating cost per barrel of oil produced, c_{capex} is the capital expense of a new well, δⁿ is an indicator that equals unity if a new well is drilled on timestep n (and 0 otherwise), and y is the discount factor. Accordingly, the total rewards through the end of the project are Equation 9:

$$R = {\sum }_{t = 0}^{H} [ ( {p}_{o} - {c}_{opex} ) {q}^{n} - {δ}^{n} {c}_{capex} ] {γ}^{t} \qquad Equation 9$$

where the horizon H in this case is the life of the project. Equation 9 also corresponds to the definition of NPV. In other words, the way the rewards are defined is such that the DRL AI maximizes the NPV. If the objective function of the optimization is different, the definition of the reward will typically need to be modified accordingly, and the AI will typically need to be retrained.

Definition of Actions: For a 2D model of the size nₓ×n_{y}, the set of plausible actions consists of nₓ×n_{y}+1 elements. At each timestep, the agent can choose one of the nₓ×n_{y} to drill a well or choose to not drill at all. Some of the actions, such as drilling at a location where there is an existing well or drilling on inactive cells, are obviously not optimal. Such logic will be considered through an action mask that will be discussed in subsequent sections.

Parameters for Training Scenario Generation: Given the equations presented in Equations 2 through 9, a list of parameters that characterizes the optimization scenario is summarized in Table 1. It includes geological information, rock and fluid properties, operational constraints, and economic parameters. This means that the resulting AI can generalize over different geological structures, rock and fluid properties, operational constraints, and economic parameters within the specified range. These variables are static in the sense that they do not change over time.

TABLE 1
List of parameters for 2D single-phase field development optimization.

| Number | Symbol | Description | Minimum | Maximum | Spatial Distribution |
|---|---|---|---|---|---|
| 1 | dₓ | x-direction cell size (ft) | 400 | 600 | N/A |
| 2 | d_{y} | y-direction cell size (ft) | 400 | 600 | N/A |
| 3 | d_{datum} | Datum depth (ft) | 5,000 | 7,000 | N/A |
| 4 | p_{ref} | Reference pressure at | 7,000 | 9,000 | N/A |
| | | datum (psi) | | | |
| 5 | h | Net thickness (ft) | N/A | N/A | SGS (200, 20, 30, 60) |
| 6 | d | Depth from datum (ft) | N/A | N/A | SGS (0, 20, 30, 60) |
| 7 | ϕ | Porosity | N/A | N/A | SGS (0.2, 0.05, 3, 5) |
| 8 | k | Permeability (md) | N/A | N/A | Cloud transform |
| | | | | | from ϕ |
| 9 | active | Active cell indicator | 0 | 1 | Random elliptical |
| 10 | cₜ | Total compressibility | 1 × 10⁻⁵ | 5 × 10⁻⁵ | N/A |
| | | (psi⁻¹) | | | |
| 11 | γₒ | Oil specific gravity | 0.5 | 1 | N/A |
| 12 | μ | Oil viscosity (cp) | 2 | 4 | N/A |
| 13 | B | Oil formation volume | 1 | 2 | N/A |
| | | factor | | | |
| 14 | dₚ | Producer drawdown | 2,500 | 3,500 | N/A |
| | | (psi) | | | |
| 15 | s | Producer skin factor | 0 | 2 | N/A |
| 16 | c_{capex} | Cost of drilling a well | 5 × 10⁷ | 7 × 10⁷ | N/A |
| | | (USD) | | | |
| 17 | cₒₚₑₓ | Operating cost per bbl | 10 | 15 | N/A |
| | | (USD) | | | |
| 18 | pₒ | Oil price (USD) | 50 | 70 | N/A |
| 19 | γ | Discount factor | 0.89 | 0.91 | N/A |
| 20 | H | Project horizon | 15 | 20 | N/A |

N/A = not applicable.

Also shown in Table 1 are the ranges of the static variables according to which the scenarios are randomly generated during the training stage. Note that the net thickness, datum depth, and porosity spatial properties are generated by sequential Gaussian simulations (SGSs) following certain statistics. The variables a, b, c, and d in the notation SGS(a,b,c,d) denote the mean, the standard deviation, and the x- and y-direction variogram ranges (in number of gridblocks), respectively.

The ranges in Table 1 are referred to as the ranges of applicability in the sense that once the DRL AI is trained, it should be able to handle new scenarios within this range of applicability. If the new scenario is outside of the range of applicability, the DRL AI could be extrapolating beyond the training set, and its performance could be unreliable. The wider the range of applicability, the stronger the capability of the DRL AI to generalize to new scenarios, but it is also harder to train. Specifically, the ranges in Table 1 are derived from ranges commonly observed in deepwater reservoirs in the Gulf of Mexico. The resulted AI is expected to be applicable to reservoirs with similar properties. For the same reason, the AI in this disclosure is not expected to handle scenarios that are dramatically different, such as the highly channelized reservoirs in deepwater Nigeria. For those Nigerian cases, the DRL framework still applies but the training set (e.g., Table 1) should be enriched with features of the new scenarios.

The wider the range of applicability, the stronger the capability of the DRL AI to generalize to new scenarios, but it is also harder to train.

Definition of State: The set of scenario parameters together with the two dynamic variables pressure p and time t form a valid definition of state in an MDP because once it is given, there is enough information about the future evolution of the environment. However, such a definition of the states is not favorable as the scenario parameters in Table 1, and the dynamic variables do not affect the environment independently. For example, it is the pₒ−cₒₚₑₓ that impacts the rewards rather than the pₒ or the cₒₚₑₓ individually. This indicates that it may be possible to describe the state of the environment with a smaller number of state variables (also called input channels from the perspective of the neural network). In addition, the size of the neural network and the computational cost scale with the number of input channels. Therefore, there is desirable to use the smallest number of channels to represent the environment state.

Table 2 shows the list of state variables (input channels) designed for the targeted 2D single-phase flow problem. The set of scenario parameters and the dynamic variables have been compressed down to 11 states. The rationale behind the selection of the states is that they are primarily the parameter groups that appear in the Equations 2 through 9. These observations affect the system equations more independently than the scenario parameters individually and thus could relate more directly to the dynamic state (pressure) evolution, the rewards, and the optimal actions. This could potentially help make the policy network of the agent easier to train. The list of states in Table 2 still ensures the environment is Markovian in the sense it contains enough information about the future evolution of the environment.

TABLE 2
List of states (input channels for Al) for 2D single-phase
field development optimization.

| Input | | | |
|---|---|---|---|
| Channel | | Static/ | |
| Number | Definition | Dynamic | Scaling Function |
| 1 | $\frac{( cr + cf ) ϕ {VS}_{o}}{B}$ | Static | f(x) = [x − min(x)]/ [max(x) − min(x)] |
| 2 | p | Dynamic | f(x) = [x − min(x)]/ |
| | | | [max(x) − min(x)] |
| 3 | Tₓ | Static | f(x) = x/(x + x̅) |
| 4 | T_{y} | Static | f(x) = x/(x + x̅) |
| 5 | γₒ(d − d_{datum}) | Static | f(x) = [x − min(x)]/ |
| | | | [max(x) − min(x)] |
| 6 | $\frac{{c}_{capex}}{{p}_{o} - {c}_{opex}}$ | Static | f(x) = [x − min(x)]/ [max(x) − min(x)] |
| 7 | Y^{t} | Dynamic | f(x) = x |
| 8 | PI | Static | f(x) = x/(x + x̅) |
| 9 | p_{BH} | Static | f(x) = [x − min(x)]/ |
| | | | [max(x) − min(x)] |
| 10 | active | Static | f(x) = x |
| 11 | H − t | Static | f(x) = [x − min(x)]/ |
| | | | [max(x) − min(x)] |

For model-based FDP optimization, it can be assumed that the observation of the agent is the full state as shown in Table 2. The distinction between observation and state will not be made hereafter.

At step 210, the process 200 includes normalizing the varying values of the input channels to generate normalized values of the input channels. In some embodiments, at least one two dimensional (2D) digital image (e.g., 2D map) is utilized to represent the values after normalization of each input channel. In some embodiments, at least one three dimensional (3D) digital cube is utilized to represent the values after normalization of each input channel. Some non-limiting embodiments are provided hereinbelow.

Normalizing: As will be detailed in later sections herein, for a 2D reservoir template, each of the 11 channels in Table 2 herein will be represented as a 2D map. These 11 maps will be stacked together to form the input for the neural network for the agent. Neural networks work best when the values of different input channels are normalized to the same scale, such as between zero and unity or −1 and unity. Therefore, different scaling functions are designed and applied to different input channels before they go into the neural networks. These scaling functions are listed in Table 2. For Tₓ, T_{y}, and PI, whose distributions tend to be highly skewed, a nonlinear scaling function is applied to even out the distributions. For all other channels, simple linear scaling is applied. The parameters in the scaling function max(x), min(x), and x̅ are the maximum, minimum, and mean of the values of channel×respectively, obtained from 50 random environment evaluations before the training.

At step 215, the process 200 includes constructing a policy neural network and a value neural network that project a state represented by the normalized values of the input channels to a field development action and a value of the state respectively. In some embodiments, at least portions of the policy neural network and the value neural network comprise convolution layers and residual blocks. In some embodiments, the policy neural network and the value neural network share weights in at least one layer. In some embodiments, the policy neural network and the value neural network do not share weights. In some embodiments, the policy neural network and the value neural network comprise an action embedding layer to force the policy network to learn low dimensional representations of actions during the training. In some embodiments, action masking is applied to invalidate at least one user-defined invalid action during the training. Some non-limiting embodiments are provided hereinbelow.

Neural Networks: As stated herein, the policy function π_{θ}(a|s) and the value function V^{s}(sᵢ) are modeled by deep neural networks. The input of these two neural networks is a stack of maps for the input channels listed in Table 2 after scaling. The high-level structure of the neural network that is used in some embodiments herein is shown in FIG. 3.

Convolution Layers: Convolution layers are the main building blocks in the network to extract spatial features from the input map. Given a stack of 2D inputs of the size nₓ×n_{y}×n_{c}, where n_{c} is the number of input channels, at a 2D convolution layer, a set of nₖ learnable kernels of the size (n_{f}×n_{f}×n_{c}) is applied to the input. A convolution kernel is a 3D matrix, and its elements are weights. A kernel strides along the x- and y-directions of the input domain at a certain step size. At each location, it performs the convolution operations, in which the inner product of the kernel matrix and the patch of input data at that location are taken, resulting in a scalar output. After the nₖ kernels traverse the entire domain, the output would have nₖ channels instead of n_{c}.

Specifically for the problem of interest, the input scaled state s is of the size 50×40×11. The first convolution layer directly after the input has 48 kernels (nₖ=48). The kernel size is 3×3×11, with a stride size unity along both the x- and the y-directions. Padding is used to augment the borders of the input matrix with zeros such that the input and the output of the convolution layer have the same dimension in the x- and the y-directions. Therefore, the output after the first convolution layer has 48 channels and is a 3D matrix of the size 50×40×48. The convolution layers in the residual blocks (to be discussed below herein) also have 48 kernels, but the input size for these layers is 50×40×48, and therefore the kernel sizes are 3×3×48. The convolution layer directly after the last residual block has only two kernels, and the sizes of the kernels are 1×1×48. Therefore, the output from this layer is of the size 50×40×2. This layer acts as a buffer as the size of the output would ultimately be reduced to the size of the action space (50×40+1).

Activation with ReLU: Convolution layers perform a linear operation on the input. Activation functions add nonlinearity to the neural network. In some embodiments herein, the rectified linear unit (ReLU) is used as the activation function. ReLU is in the form of ƒ(x)=max(θ,x). ReLU has been shown to be less susceptible to the vanishing-gradient problem in training deep neural networks.

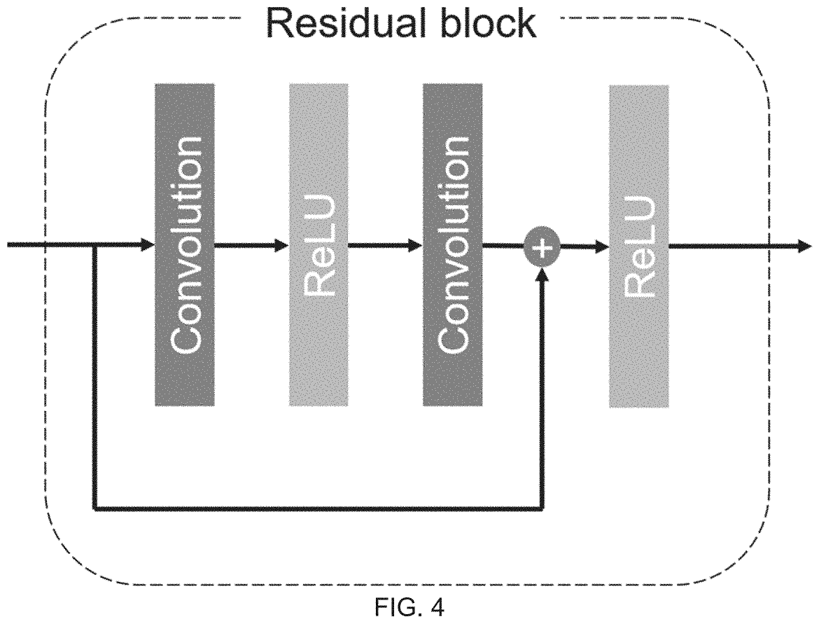

Residual Blocks: The residual blocks shown in FIG. 3 are a construct made up of multiple layers. As shown in FIG. 4, a residual block includes a convolution layer following an activation layer and another convolution layer. After that, the initial value of the input will be added to the output of the convolution layer, and the result will go through another layer of activation.

The structure of residual blocks was proposed to avoid the famous vanishing-gradient problem, in which the gradient of the loss function with respect to the earlier layers of the network becomes vanishingly small due to error accumulation in the backpropagation in the deep neural network. By allowing the input to bypass layers of the neural network, the use of residual blocks has been shown to effectively maintain the magnitude of the gradient to weights on earlier layers of the network.

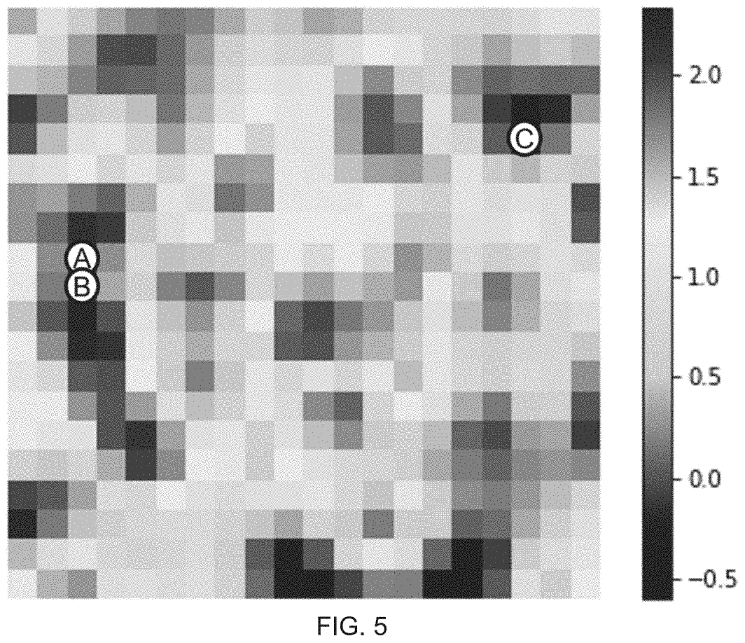

Action Embedding: The output of the policy network is a vector containing the probability for the nₓ×n_{y}+1 plausible actions. In other words, the action probability vector is in an nₓ×n_{y}+1(1D) space. The similarity relation of these nₓ×n_{y}+1 actions is lost in this representation. For example, for a reservoir shown in FIG. 5, the actions of drilling a well at Location A and drilling a well at Location B are similar physically, and they are very different from drilling a well at Location C. However, in the nₓ×n_{y}+1(1D) space of the action probability, the three actions are equally distanced from each other because they are all unit vectors where it is unity at the well location and zero everywhere else.

Maintaining the similarity structure of the action space is important for the robustness of the policy function because it is desirable that a small perturbation in states lead to a similar action rather than a dramatically different one. Similar problems have also been reported in the application of the DRL in other areas, such as in natural language processing, in which the AI tries to determine the most relevant text (actions) following a given piece of text (the state). In that case, the plausible actions are words from a dictionary. The similarity relation between words, such as between a noun and its plural form, is lost when plausible actions are represented as a vector. It has been proposed that both state and action embedding be utilized to address this problem. Action embedding nonlinearly transforms the action space into another space where the physical similarity between actions could be better honored. The transformation is part of the neural network and is learned during the training process.

Some embodiments herein implemented the action embedding as a fully connected layer, called the action embedding layer, before the final output layer. The number of nodes in this layer is much smaller than the number of possible actions at the final output layers. Each action will be represented by a direction in this n_{embed}-dimensional space. The similarity of the actions will be represented by the degree of alignment in this n_{embed}-dimensional space. Through this compression, the network is forced to exploit/learn the relations between the different actions through the training samples. Although the obtained action embedding matrix will not be explicitly used as those in natural language processing, the action embedding implementation herein implicitly forces the policy network to explore the high-level representation of actions and effectively reduces the overfitting in the training.

Action Masking: Given the states of the environment, a portion of the plausible action set can easily be ruled out based on commonsense by a human engineer. For example, the next well should not be drilled at inactive cells or in the immediate vicinity of existing wells. However, AI has no knowledge of this engineering commonsense and has to learn it from a large amount of training data. Even with a large amount of training data, the AI could still take nonsensical actions in some scenarios. Encoding engineering commonsense into the AI could potentially accelerate its convergence and improve the quality of the policy. This is accomplished by action masking in some embodiments herein.

The output after the action embedding layer is a vector of the log-probability of each action. The action masking layer after that sets the log-probability of user-defined invalid actions to—inf (equivalent to setting the probability of invalid actions to zero). In some embodiments herein, invalid actions are defined, such as drilling at inactive cells or drilling at the immediate vicinity of the existing wells. The advantage of action masking is that it ensures the AI agent to only take valid actions during both the training and testing stage so that it can avoid wasting time on exploring unfavorable solutions.

At step 220, the process 200 includes training the policy neural network and the value neural network using deep reinforcement learning on the plurality of training reservoir models with a reservoir simulator as an environment such that the policy neural network generates a field development plan comprising well counts, well locations, well type, well sequence, or any combination thereof to improve profitability of a hydrocarbon field development. In some embodiments, the profitability of the hydrocarbon field development is represented by net present value (NPV), discounted profitability index (DPI), estimate ultimate recovery (EUR), or any combination thereof. In some embodiments, the deep reinforcement learning comprises proximal policy optimization (PPO), Importance weighted Actor-Learner Architecture (IMPALA), or any combination thereof. In some embodiments, a stochastic gradient descent (SGD) algorithm is utilized during the training. In some embodiments, the reservoir simulator is a single-phase reservoir simulator. In some embodiments, the reservoir simulator is a multi-phase reservoir simulator. Some non-limiting embodiments are provided hereinbelow.

PPO: While there are a variety of RL algorithms available in the literature such as, but not limited to, PPO and IMPALA. PPO has achieved much success and was the method used in some embodiments herein. This section describes the PPO algorithm following the particular implementation that was used.

RL as an Optimization Problem: PPO is a type of policy gradient method. In policy gradient methods, the action taken by the agent is described as a stochastic function of the observation. The probability of the agent choosing action a given state s is written as π_{θ}(u|s), where θ are the parameters to be optimized. When π_{θ}(u|s) is modeled by a deep neural network, θ would be the weights of that network.

The expected total reward when the agent follows policy π_{θ} can be written as

$$U = E [ {\sum }_{t = 0}^{H} r ( {s}_{t} ) \vert {π}_{θ} ] \qquad Equation 10$$

The goal here is to find the parameter θ such that the expected total reward U is maximized. The idea of policy gradient methods is to take the gradient of U with respect to the parameters θ and update the policy along that gradient direction. Because of the high dimensionality of θ and the large number of samples, SGD is often used for the optimization. However, the conventional policy gradient methods have been shown to generate large update steps that often lead to instability. Much of the research in policy gradient methods has been focused on getting a numerically stable formulation of the optimization problem. PPO (Schulman, J., Wolski, F., Dhariwal, P. et al. 2017. Proximal Policy Optimization Algorithms. available at https://arxiv.org/abs/1707.06347, which is incorporated by reference) is one such variant.

The objective function in PPO that is used in some embodiments herein is a weighted combination of four components: (A) a policy loss L^{π}, (B) a Kullback-Leibler (KL) divergence penalty L^{kl} (see Kullback, S. and Leibler, R. A. On Information and Sufficiency. Ann Math Stat22 (1): 79-86. 1951. available at https://doi.org/10.1214/aoms/1177729694, which is incorporated by reference herein), (C) a value function loss L^{vf}, and (D) an entropy penalty L^{ent}. It can be written as Equation 11 hereinbelow:

L^{PPO}=L^{π}+cₖₗL^{kl}+cᵥₗL^{vf}+cₑₙₜL^{ent} Equation 11:

where cₖₗ, c_{vf}, and cₑₙₜ are the weights for each individual loss component.

Policy Loss: The policy loss L^{π} is a surrogate for maximizing the expected reward in the RL problem. With some mathematical manipulation, it can be shown that maximizing the expected total reward U is equivalent to minimizing the following loss function:

L_{PG}=−Êₜ[log π_{θ}(aₜ|sₜ)Ât Equation 12:

where A(t) is called the advantage function, and its value for sample i can be expressed as:

$${A}^{( i )} ( t ) = {\sum }_{k = t}^{H} r [ {s}_{k}^{( i )} , {a}_{k}^{( i )} ] - b [ {s}_{t}^{( i )} ] \qquad Equation 13$$

where b[sₜ⁽ⁱ⁾] is a baseline that represents the average future rewards that can be obtained given that the system is in state sₜ⁽ⁱ⁾ at time t. The advantage function A⁽ⁱ⁾(t) represented how much more the policy π_{θ} can yield in terms of future rewards given state sₜ⁽ⁱ⁾ at time t, when compared to a baseline b[sₜ⁽ⁱ⁾]. Âₜ is the empirical mean of A(t) over the current batch of training samples.

An intuitive interpretation of Equation 12 is that to increase the total expected reward U, the parameters θ need to be adjusted to increase the probability of good state-action sequences that outperform the baseline [i.e., A⁽ⁱ⁾(t)>0]], and decrease the probability of the bad state-action sequences that underperform the baseline [i.e., A⁽ⁱ⁾(t)<0]]. The choice of A⁽ⁱ⁾(t) will be discussed further in the subsequent section on value function loss.

Equation 12 is the foundation for most policy gradient methods. However, directly minimizing Equation 12 using SGD has been shown to be numerically unfavorable for two reasons. First, it can sometimes result in very large update steps, driving the optimization process unstable. Second, the gradient estimate for SGD can be very noisy without a carefully designed advantage function. A modified policy loss function has been proposed to address the first challenge. It is written as:

L^{π}=−Êₜ(min{rₜ(θ)Âₜ,clip[rₜ(θ),1−ε,1+ε]Âₜ}) Equation 14:

where rₜ is the ratio of a new policy π_{θ} to an old policy π_{θ}_{_{old}} from which training samples are collected. The first term in the min( ) operator is a first-order approximation of Equation 12 at θ_{old}. The second term in the min( ) operator clips the objective function when rₜ(θ)<1−ε or when rₜ(θ)>1+ε. In other words, it removes the incentives of the algorithm for modifying the policy too far away from the existing one. It has been shown that such clipping significantly improves the stability of the gradient-based optimization process.

Advantage and Value Function Loss: Another challenge of policy optimization using SGD is that the dimension of the parameters θ is usually much higher than the number of samples in a training batch. Therefore, the estimate of gradient for Equations 12 or 14 during the training process (i.e., SGD) can be of high variance (noisy). Much of the recent research has been devoted to finding a numerically stable formulation of the advantage function, and to finding an optimization method that is stable under very noisy gradient estimate.

First, because the baseline b[sₜ⁽ⁱ⁾] does not depend on θ, in theory, it does not affect the gradient calculation. It is included to improve the numerical performance of the algorithm. Therefore, different formulations of b[sₜ⁽ⁱ⁾] are permissible as long as they remain independent of θ. Second, while Equation 12 is unbiased when advantage function formulated as in Equation 13, it has been shown that there is a trade-off between bias and variance. By allowing for some bias in the gradient estimate, the variance (noise) of the estimate could be substantially reduced.

The flexibility in the formulation of the advantage A⁽ⁱ⁾(t) has given rise to a large number of variants of the policy gradient methods. One approach provided a generalized framework for the estimation of the advantage function called generalized advantage estimation and the advantage function is expressed as:

$${A}_{t}^{GAE ( {γ}_{i} λ )} ( t ) = {\sum }_{l = t}^{H} {( γ λ )}^{l - t} [ {r}_{l} + γ {V}^{π} ( {s}_{l + 1} ) - {V}^{π} ( {s}_{l} ) ] \qquad Equation 15$$

where the two parameters γ and λ can be viewed as extra discounting on the reward function that lower the variance at the cost of introducing biases.

When γ=λ=1 and H→∞, Equation 15 recovers the unbiased form of Equation 13 with the baseline b(sₜ) defined by V^{π}(sₜ), which is the value function for the current policy defined as:

$${V}^{π} ( {s}_{t} ) = E [ {\sum }_{l = t}^{H} {r}_{l} ] \qquad Equation 16$$

The value function V^{π}(sₜ) represents the expected total reward of being in state sₜ at time t and then acting according to policy π till the end. In PPO, the value function is also modeled by a deep neural network with weight parameters ψ. In some prior works, the value network and the policy network share layers so parameters in θ and ψ overlap. This requires careful selection of the relative weights for policy and value loss in Equation 11 because the two losses will be impacting the same set of network parameters. In some embodiments herein, the policy network and the value network do not share layers, so parameters θ and ψ are independent.

The loss for value function is formulated as:

L=Êₜ(max{[V_{ψ}(sₜ)−V_{target}(sₜ)]²,[V_{ψ}_{_{old}}+clip(V_{ψ}(sₜ)−V_{ψ}_{_{old}}(sₜ),−η,η)−V_{target}(sₜ)]²}) Equation 17:

where the V_{target}(sₜ) is the value function obtained from the training runs, and V_{ψ}_{_{old}} is the value function using the current set of parameters Wow. Similar to the definition of PPO policy loss in Equation 14, the purpose of the first term in the max( ) operator is to drive the value function to match with data obtained from training. The purpose of the second term in the max( ) operator is to remove the incentive of large update on ψ by clipping the gradient to zero when V_{ψ}(sₜ) is too different from V_{ψ}_{_{old}}(sₜ).

KL Divergence Loss and Entropy Loss: Similar to the clipped loss functions in Equations 14 and 17, the KL divergence penalty LKL is introduced to regulate step sizes in SGD. The KL divergence penalty is written as:

L^{KL}=Êₜ[D_{KL}(π_{θ}|π_{θ}_{_{old}})] Equation 18:

where D_{KL}(π_{θ}|π_{θ}_{_{old}}) is the KL divergence (see Kullback, S. and Leibler, R. A. On Information and Sufficiency. Ann Math Stat22 (1): 79-86. 1951. https://doi.org/10.1214/aoms/1177729694, which is incorporated by reference herein) that measures the difference from π_{θ}_{_{old}} to π_{θ}. By penalizing the loss function with the KL divergence, the algorithm is discouraged from taking too big an update step from π_{θ}_{_{old}} to π_{θ}.

Finally, the entropy loss is defined as:

Lₑₙₜ=Êₜ[S(π_{θ})] Equation 19:

where S(π_{θ}) is the Shannon information entropy of the probability distribution π_{θ} (see Shannon, C. E. A Mathematical Theory of Communication. Bell Syst Tech J27 (3): 379-423. 1948. https://doi.org/10.1002/j.1538-7305.1948.tb01338.x, which is incorporated by reference). The Shannon information entropy measures how diverse a probability distribution is. A low S(π_{θ}) indicates that the probability distribution in policy π_{θ} is concentrated in a few actions, which could be a sign of premature convergence. The entropy loss term encourages the algorithm to keep exploring different actions and helps avoid premature convergence.

SGD: During each iteration of the training process, a batch of scenarios are randomly generated according to the range of applicability. The agent interacts with the environment according to the current policy. The state, action, and reward at each timestep are saved to form a training data set. SGD is then applied to minimize the total loss defined in Equation 11. At each iteration step of the SGD, a random subset of the training data set is sampled. This subset is called an SGD minibatch. The gradient of the total loss is evaluated on this SGD minibatch, and the policy and value function parameters θ and ψ are updated along the gradient direction with the step size of α, which is called the learning rate.

SGD is widely used for training deep learning models with a large number of parameters because it reduces the computational burden for gradient evaluation and helps alleviate the impact of local optima and saddle points.

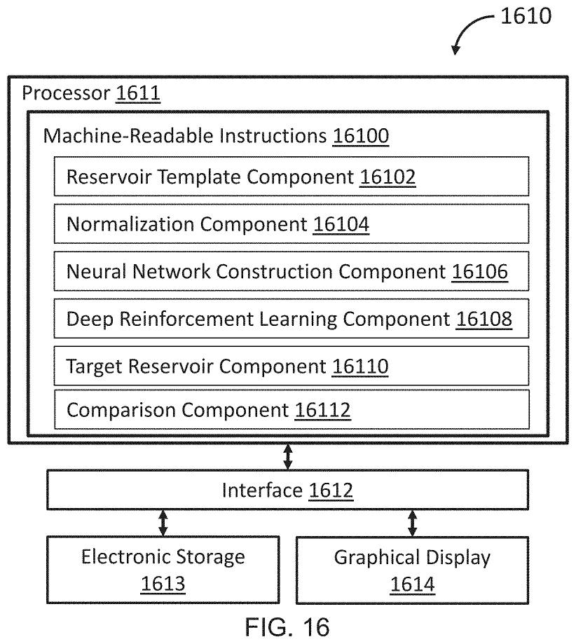

At step 225, the process 200 includes storing, such as storing the trained policy network and any other items from the training stage to be used in the application stage. The trained policy network and any other items from the training stage to be used in the application stage may be stored in electronic storage 1613 in FIG. 16. Thus, the trained policy network and any other items from the training stage may be obtained from the electronic storage 1613 to be used in the application stage (e.g., starting at step 230). In some embodiments, the same party may perform the training stage and the application stage.

However, in some embodiments, a first party may perform the training stage and a second party (where the second party and the first party are different) may perform the application stage. The second party may obtain the trained policy network and any other items from the training stage to proceed with the application stage (e.g., see FIG. 2B). For example, the second party may obtain the trained policy network and any other items from the training stage to proceed with the application stage from the electronic storage 1613, or alternatively, the trained policy network and any other items from the training stage may be shared with the second party from the electronic storage 1613. Those of ordinary skill in the art will appreciate that other options are also possible.

At step 230, the process 200 includes obtaining values for the input channels according to the reservoir template for a target reservoir (e.g., obtain values from core analysis reports, well testing, corefloods, using sensors, etc. for the target real reservoir); rescaling and normalizing the obtained values for the input channels to generate rescaled and normalized target input values; generating a field development plan for the target reservoir on the reservoir template with the rescaled and normalized target input values, the trained policy network, and the reservoir simulator; and rescaling the generated field development plan to scale of the target reservoir model to generate a final field development plan for the target reservoir. The process 200 may also include outputting, on a graphical user interface, at least a portion of the final field development plan. In some embodiments, the at least one portion of the final field development plan is output to one or more digital images (e.g., well locations are shown using coordinates as illustrated in FIG. 1B). Outputting may include generating a visual representation of the final field development plan as illustrated in FIG. 1B and then displaying it to a user via graphical display 1614 of FIG. 16. In some embodiments, action masking may be applied to invalidate at least one user-defined invalid action during generating the field development plan for the target reservoir. Some non-limiting embodiments are provided hereinbelow.

As illustrated in FIG. 1B, when the DRL AI is applied to a real reservoir, the process includes rescaling the real reservoir to the reservoir template and deriving the values for the environment state. The state is then converted to observations for the AI. If the value of the observation is within the range of applicability, the information is then passed to the DRL AI, which outputs the optimized development plan on the reservoir template. This optimized development plan is then mapped back to the real reservoir before it is further evaluated.

The ranges in Table 1 are referred to as the ranges of applicability in the sense that once the DRL AI is trained, it should be able to handle new scenarios within this range of applicability. If the new scenario is outside of the range of applicability, the DRL AI could be extrapolating beyond the training set, and its performance could be unreliable. The wider the range of applicability, the stronger the capability of the DRL AI to generalize to new scenarios, but it is also harder to train. Specifically, the ranges in Table 1 are derived from ranges commonly observed in deepwater reservoirs in the Gulf of Mexico. The resulted AI is expected to be applicable to reservoirs with similar properties. For the same reason, the AI in this work is not expected to handle scenarios that are dramatically different, such as the highly channelized reservoirs in deepwater Nigeria. For those Nigerian cases, the DRL framework still applies but the training set (i.e., Table 1) should be enriched with features of the new scenarios.

Errors could occur during the process of rescaling to and from the reservoir template. The more detailed the reservoir template (e.g., three dimensional (3D), larger size, the more complete characterization of the states), the lower the rescaling error would be. However, even with the presence of some rescaling error, it is reasonable to expect the optimal solution on the reservoir template to still be close to optimal on the real reservoir.

At step 235, the process 200 includes comparing the final field development plan for the target reservoir against at least one other field development plan for the target reservoir (e.g., as discussed in connection with non-limiting EXAMPLE_1). The at least one other field development plan is generated by a human, by an optimization algorithm, or any combination thereof.

In contrast to FIG. 2A, FIG. 2B illustrates process 250 that focuses on the application stage after the training stage (e.g., generating a field development plan for the target reservoir on the reservoir template with the rescaled and normalized target input values, the trained policy network, and the reservoir simulator and rescaling the generated field development plan to scale of the target reservoir model to generate a final field development plan for the target reservoir). Process 250 in FIG. 2B includes step 255 (similar to step 230 in FIG. 2A as described hereinabove) and optionally step 260 (similar to step 235 in FIG. 2A as described hereinabove). Process 250 may be pursued using, for example, a previously trained policy network (e.g., stored at step 225 in FIG. 2A). As discussed hereinabove, in some embodiments, a first party may perform the training stage and a second party (where the second party and the first party are different) may perform the application stage. The second party may obtain the trained policy network and any other items from the training stage to proceed with the application stage (e.g., see FIG. 2B). For example, the second party may obtain the trained policy network and any other items from the training stage to proceed with the application stage from the electronic storage 1613 in FIG. 16, or alternatively, the trained policy network and any other items from the training stage may be shared with the second party from the electronic storage 1613 in FIG. 16.

EXAMPLE_1—Problem Description: In this section, the performance of a DRL AI that is trained to perform single-phase FDP optimization is shown. The AI is trained on a 2D reservoir template of size 50×40×150×40×1. The training scenarios are generated according to the range of parameters listed in Table 1. It is assumed that a maximum of 20 wells can be drilled at the speed of 1 well per quarter (90 days) for the first 20 quarters of the asset life. The drilling speed assumed here is typical for deepwater Gulf of Mexico reservoirs with two concurrent rigs, which is the type of scenario targeted by the AI. If the goal is for the AI to generalize over different drilling speeds, the speed of drilling can also be included in the problem parameters in Table 1, which would then become parts of the input channels to the neural network.

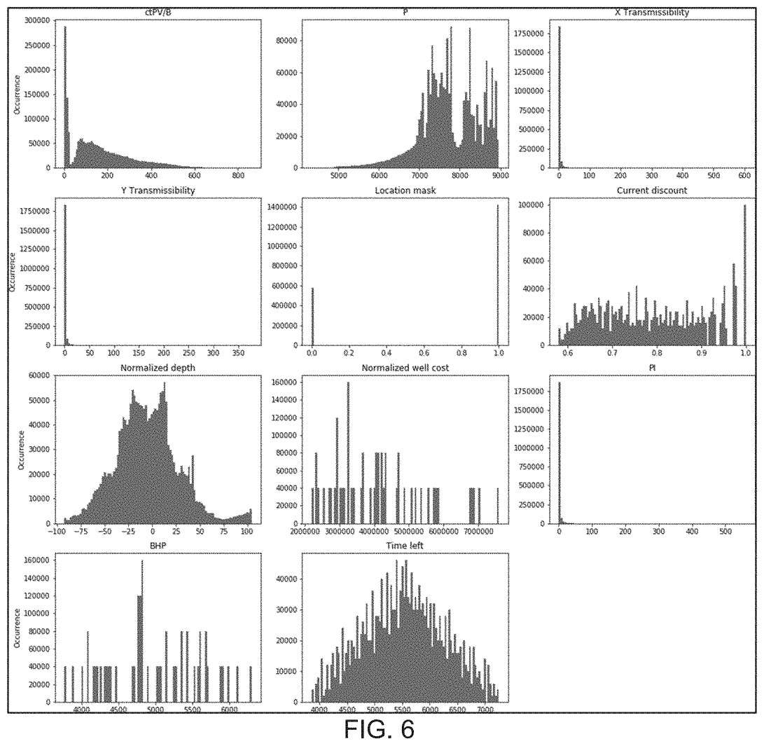

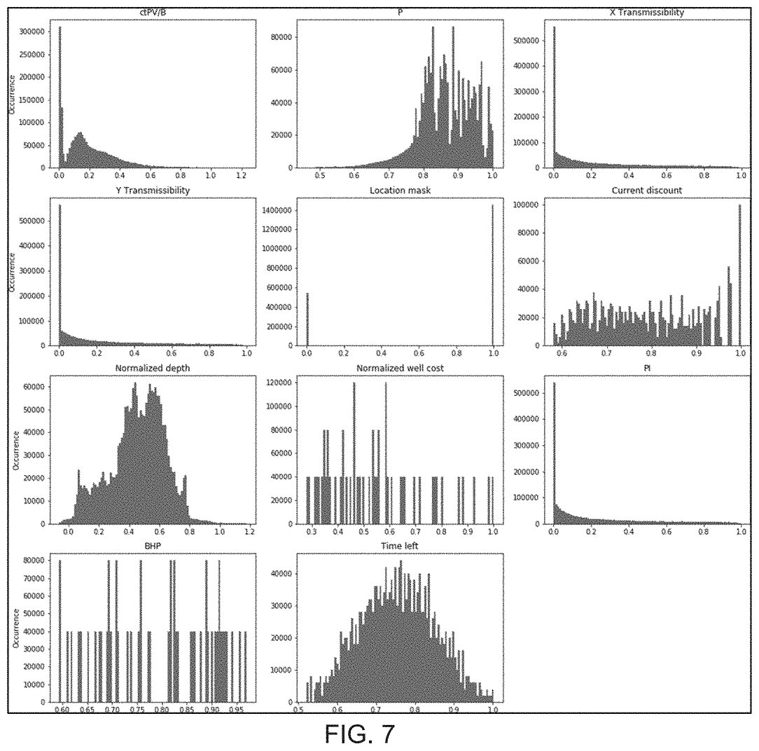

EXAMPLE_1—Performance of Adaptive Scaling: As discussed herein, the states are scaled before being input into the deep neural network. FIG. 6 shows the distribution of the 11 states before applying the scaling function, while FIG. 7 shows the distribution of the states after applying the scaling function. It can be seen that before scaling, the states can have very different scales. In addition, the distribution of transmissibility is highly skewed, with the majority of the cells at low values and a small number of the cells with orders of magnitude higher values.

After scaling functions are applied, the states are now mostly distributed between zero and unity. In addition, the skewness in transmissibility is also improved with the nonlinear scaling function.

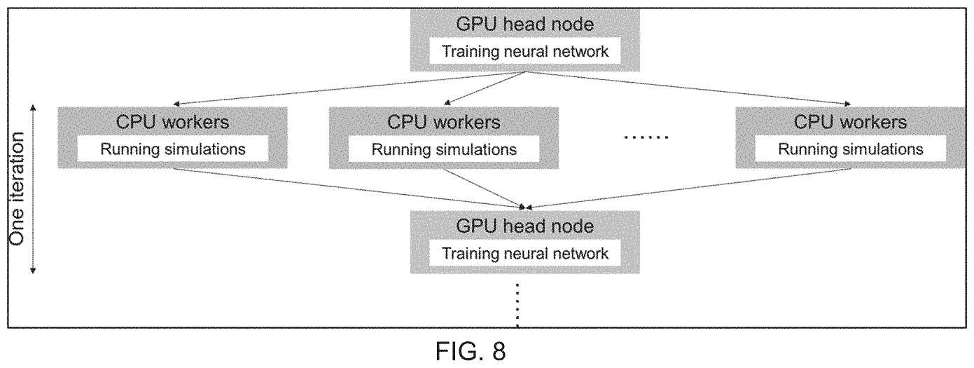

EXAMPLE_1—Performance during the Training Process: The training of the DRL AI makes use of the Ray Architecture. The computational resource for the DRL AI included 95 central processing unit (CPU) cores and four graphical processing unit (GPU) cores. As illustrated in FIG. 8, at each PPO iteration, three simulations are performed on each of the 95 CPU cores. Because a maximum of 20 wells is considered, there are 20 decision steps for each simulation of these 285 simulations, amounting to a total of 5,700 decision steps in an iteration. These 5,700 decision steps are collectively called a training batch. The information (observation, action, rewards, etc.) from the training batch then enters the GPU cores for the training of the deep neural network.

The training of the deep neural network makes use of the minibatch SGD algorithm. A total of five SGD iterations (also called SGD epochs) are performed on each training batch. During each SGD epoch, the training batch is randomly divided into multiple minibatches of the size 128, and gradient descend is performed on each of the minibatches.

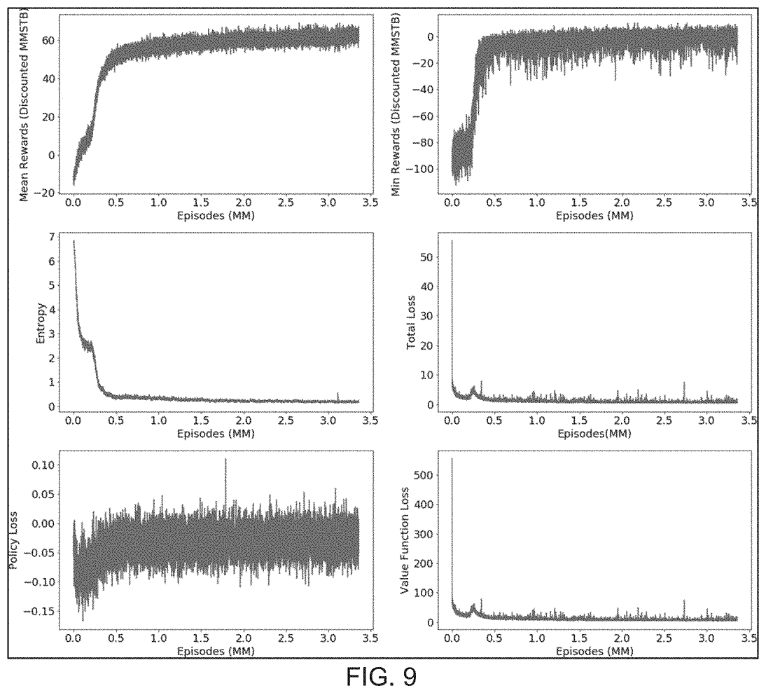

The DRL AI is trained with over 3×10⁶ simulation runs. FIG. 9 shows the evolution of some key performance indicators during the training process as the number of simulations increase. These indicators are calculated over each iteration. For example, the upper-left figure shows the mean rewards of the DRL AI averaged over the 285 training scenarios in each iteration. These 285 training scenarios are the ones that the DRL AI has not seen so far. Therefore, the mean rewards offer a meaningful metric of the AI generalization capacity. It can be seen from FIG. 9 that the mean rewards achieved by the DRL AI are generally increasing over the training period. The fluctuation is due to the randomness in training scenario generation. For example, there may be more favorable reservoirs in one iteration than another. It does not necessarily indicate fluctuation in DRL AI performance.

On the upper right is the minimum reward achieved by the DRL AI over the 285 scenarios in each PPO iteration. Because the AI always has the option not to drill any well, theoretically the minimum reward should be zero. It can be seen in the figure that the minimum reward for the DRL AI indeed approaches zero. This demonstrates that the DRL AI has learned to avoid overinvesting in unfavorable scenarios.

On the middle left is the entropy of the AI policy. This indicator reflects the randomness in the action probabilities of the DRL AI given a state. It is used as an indicator of policy convergence. It could be seen that the policy converges quickly at the beginning of the training. The convergence slows down after about 1 million episodes at a relatively low level of entropy. This indicates that the AI has “seen enough scenarios,” and has “made up its mind” about the action to take.

On the middle right, lower left, and lower right of FIG. 9 are the total loss (Equation 11), policy loss (Equation 14), and the value function loss. As discussed in previous sections, the total loss is a weighted combination of policy loss, value function loss, entropy loss, and KL divergence loss. The weight coefficients for these four loss components in this EXAMPLE_1 are 1, 0.1, 0.01, and 0.2, respectively. These values are determined by limited experimentation given the high computational cost for each trial. It can be seen in FIG. 9 that the total loss generally decreases over the training period, which is largely driven by the value function loss. On the contrary, the policy loss does not seem to decrease. This is a normal behavior in DRL with the policy loss formulated as in Equation 14. The definition of the policy loss changes in every iteration because the current policy is compared to the policy at the previous step and benchmarked with the baseline. In other words, the AI policy is chasing an increasingly challenging target.

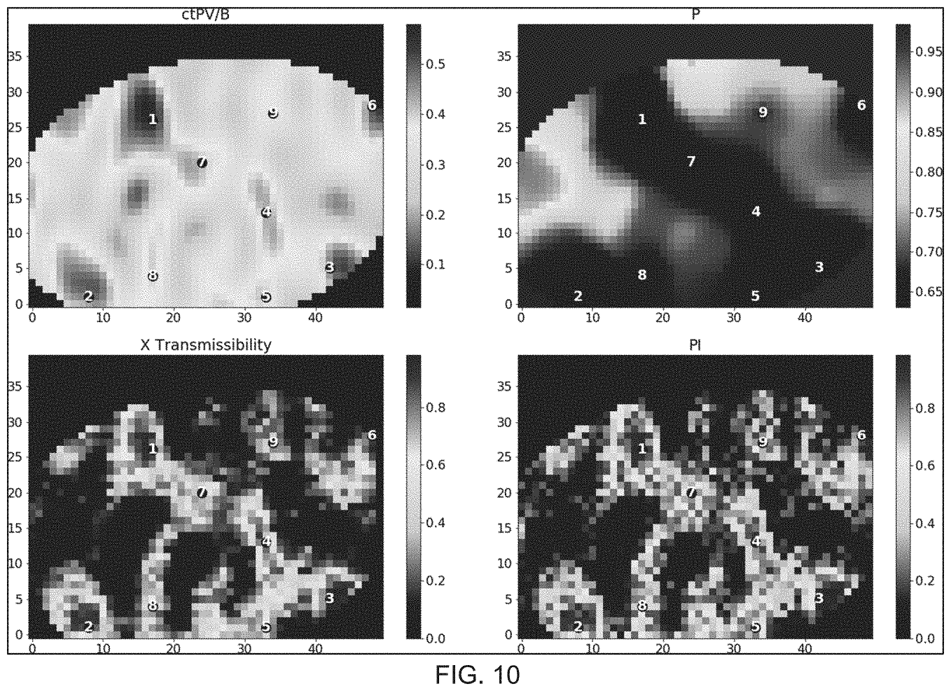

EXAMPLE_1—Example AI Solution: FIG. 10 shows the FDP solutions from the resulted AI for a representative example scenario that it has not seen before. The black dots represent locations of the wells, and the numbers on the dots represent the quarter at which the well is drilled.

The background of the four subfigures shows the value of four different observations after normalization. For example, the upper left shows the scaled “ctPV/B” in the background. The result shows that starting from zero reservoir engineering knowledge, the DRL AI learns to unity. Place the wells at “sweet spots” (high porosity/permeability locations), maintain proper well spacing, drill wells as early as possible, and select appropriate well counts. The upper right shows the scaled pressure at the end of the project horizon. It is clear that most of the productive part of the reservoir is well-drained. In addition, it is noted that a typical engineer may place at sweet spots without much difficulty. But it is usually not straightforward for human engineers to figure out the number of wells needed as well as the drilling sequence. The solution for EXAMPLE_1 from AI includes all three aspects in an optimized fashion.

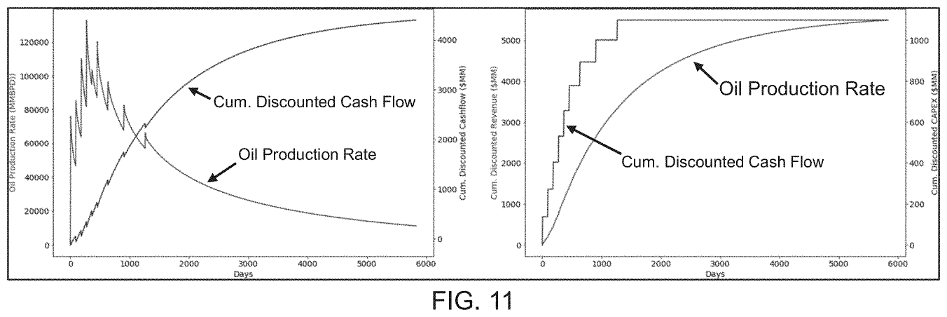

FIG. 11 shows the evolution of economic metrics for EXAMPLE_1. One line shows the oil production rate and the other line shows the cumulative discounted cash flow (NPV). It can be seen that every time a well comes online, the production rate shoots up, followed by a decline. The sharp increase is because all wells are assumed to be under BHP controls. The cumulative discounted cash flow dips every time a new well comes online because of the capital expense of the well.

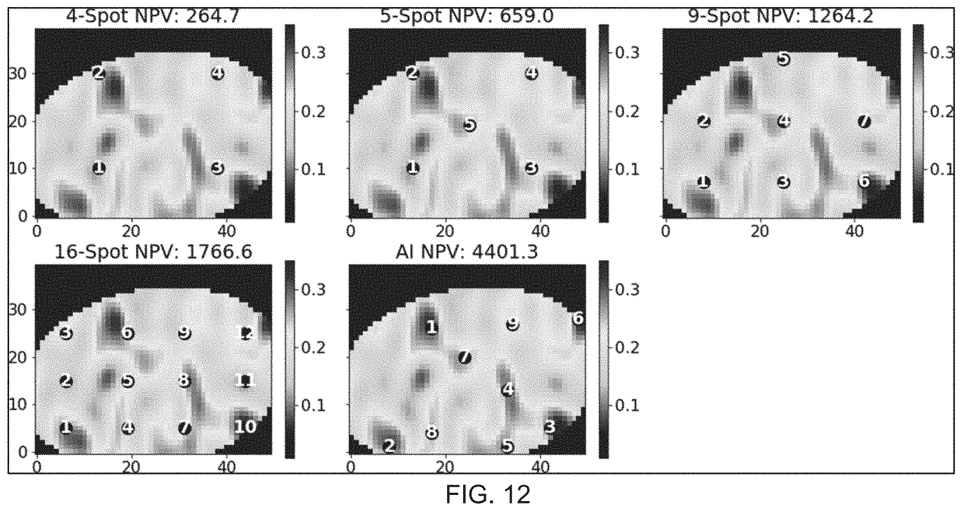

EXAMPLE_1—Statistical Benchmark of AI Performance: The performance of the DRL AI agent is benchmarked with a set of five reference agents. The first four reference agents drill wells at fixed locations in pattern to develop the field: 4-spot, 5-spot, 9-spot, and 16-spot. FIG. 12 shows the well locations for these four reference agents for an example scenario. When a well location falls into the inactive region, the agent will automatically skip the well. The fifth reference agent is an optimized pattern drilling agent referred to as “Max-Spot” which, for every given field, simulates the result for 4-spot, 5-spot, 9-spot, and 16-spot pattern development, and always picks the one with the highest NPV. The Max-Spot agent mimics a human engineer testing different pattern sizes and well spacing on a new field and picking the best solution.

The blind test is performed by generating 100 new scenarios that the AI has not seen before. These 100 scenarios are then developed separately by the DRL AI agent and the four reference agents. The NPVs achieved by the different agents are calculated for each scenario.

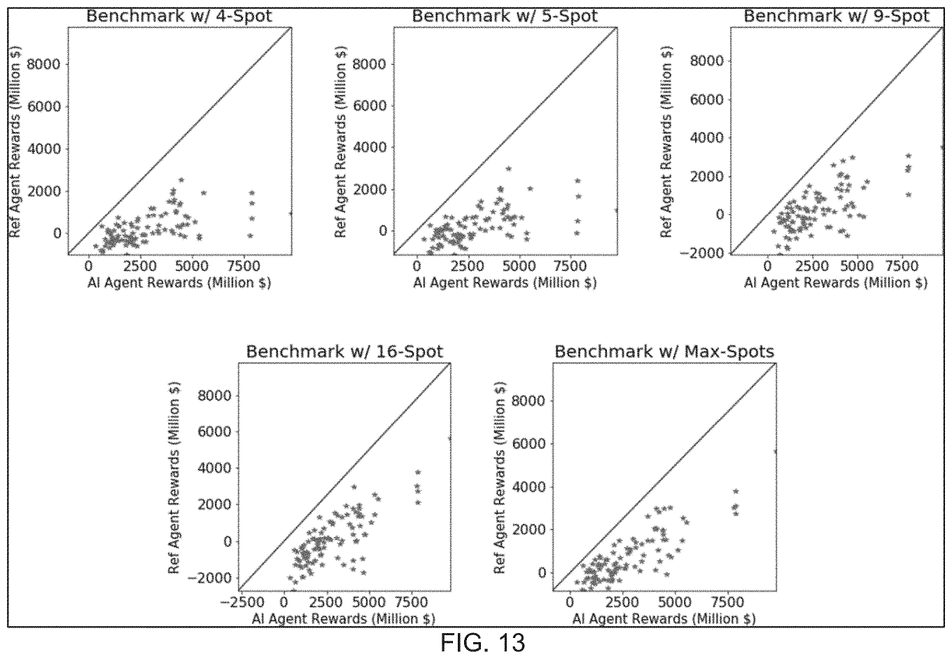

FIG. 13 shows the crossplot between the NPV achieved by the AI vs. the NPV achieved by the four reference agents, respectively. Each asterisk represents one of the 100 scenarios. The x-axis shows the NPV achieved by the AI, and the y-axis shows the NPV achieved by one of the reference agents. The line is the 45° line. When an asterisk is under the 45° line, the AI agent outperforms the reference agent for that particular scenario. It can be seen that for almost all 100 scenarios, the DRL AI outperforms the reference agents. The last subfigure in FIG. 13 shows the crossplot between the DRL AI performance and the maximum of the four reference agents for each of the 100 scenarios. It is clear that the DRL AI substantially outperforms even the maximum of the four reference agents.

It should be noted that the solutions from the reference agents are not always reasonable to a human engineer (e.g., wells could sometimes be drilled at unfavorable locations with low permeability and low porosity). A better benchmark may be to have a group of engineers empirically designing FDPs and then to compare human performance vs. the DRL AI performance.

EXAMPLE_2—Field Application of the DRL AI: While the template for the AI is single-phase and 2D, the resulted AI can be applied to real-field models to obtain good FDPs. In this EXAMPLE_2, the resulted AI is applied to a deepwater oil field in the Gulf of Mexico referred to as Field X.

The original reservoir simulation model for Field X is a high-definition 3D model with a lot of complex physics such as productivity index (PI) degradation and multiple rock and pressure/volume/temperature regions. Substantial simplification is used to extract the information from the 3D full-physics model to put into the single-phase 2D template model as input for the DRL AI.

Key simplifications of the 3D full-physics model are summarized in Table 3 hereinbelow. The reduction of model dimension is achieved by upscaling, in which the volumetric information such as initial saturation can be estimated via pore-volume weighted average, and connectivity information such as permeability can be derived through flow-based techniques.

TABLE 3
Key simplification of the 3D full-physics model.

| | Template Model | 3D Full-Physics Model |
|---|---|---|
| Dimension | 40 × 50 × 140 × 50 × 1 | 80 × 90 × 30080 × 90 × 300 |
| Water phase | Assume immobile water | Weak aquifer |
| | and single-phase flow | |
| Pressure/volume/ | Single slightly | Multiple rock and |
| temperature | compressibility system | pressure/volume/temperature |
| | | regions |
| Well productivity | Fixed PI | Considers PI degradation |
| Well controls | Constrained by BHP | Constraints by BHP, |
| | only | drawdown, and facility |
| | | capacity |

After the simulation model is simplified into the format of the reservoir template, the trained AI can be applied on Field X. It should be noted that the AI is trained with no knowledge of Field X. In addition, Field X as a real field does not necessarily follow the statistics of the training parameters outlined in Table 1. Therefore, the AI with the higher score (in terms of mean rewards) in training does not necessarily perform the best for the real field.

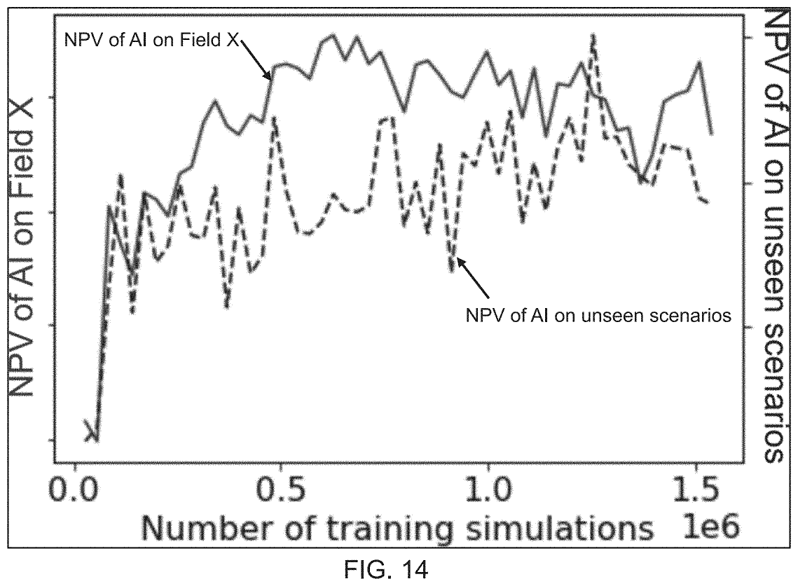

To identify the best AI for Field X, during the training, a snapshot of the AI (containing all the weights in the neural network) is saved every 100 iterations. That results in 54 different AIs at different stages of the training. FIG. 14 shows the performance of the 54 AIs on 300 new scenarios that they have not seen before (in dashed line), as well as their performance on Field X. It can be seen that while the AI performance generally increases for scenarios following the training statistics as more and more training runs are performed, the performance for Field X actually peaks midway during the training and starts to decline. This is an indicator of the start of overfitting where the AI is too accustomed to the statistics of the training set and starts to lose the ability to generalize.

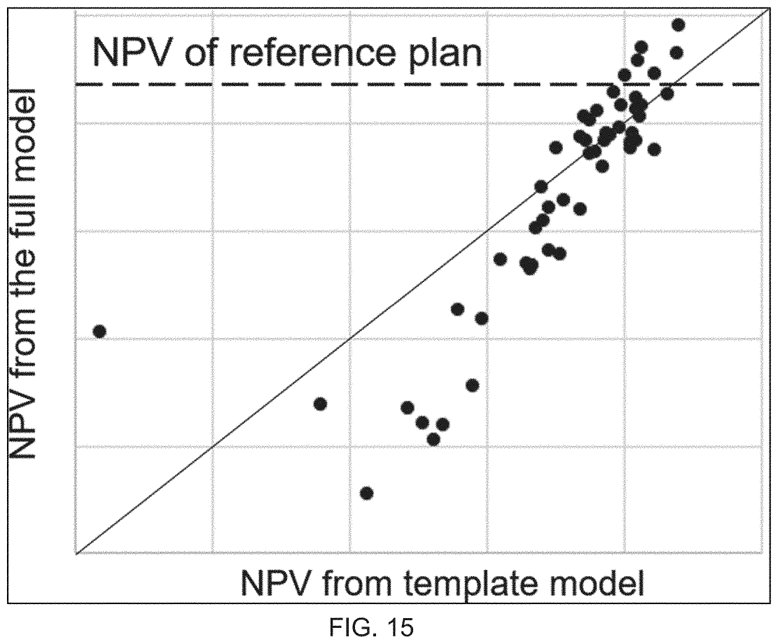

The optimal FDPs proposed by the 54 AI snapshots are evaluated on the 3D full-physics model. FIG. 15 presents a crossplot between the NPV prediction from the simplified template model (x-axis) and the NPV prediction from the 3D full-physics model. The points with very low NPV correspond to AI snapshots taken in the earlier stages of the training process before the AI is converged. The solid line is the 45° line for reference. It can be seen that while the 2D single-phase template is not very accurate (far away from the 45° line), it preserves the general order of the FDPs quite well. In other words, FDPs that have high NPVs on the template model also tend to have high NPVs on the 3D full-physics model. The dashed line in FIG. 15 represents the NPV of a reference development plan designed by the project engineers. It can be seen that the AI has identified six FDPs that have a superior NPV to the reference plan. It should be reiterated that the AI is trained beforehand for general purposes without specific information of Field X. Once trained, the computational cost to obtain these six superior FDPs is minimal and does not require the 3D full-physics simulations. The AI can also be reused to provide optimized development plans for another field without retraining.

Those of ordinary skill in the art will appreciate that various modifications may be made to the embodiments provided herein. Some modifications are provided below, but other modifications may also be made.

Extending to Multiphase Flow: Some embodiments herein discussed the DRL AI for single-phase oil flow problems. The DRL AI may be extended to multiphase flow problems, such as for waterflooding problems or gas production. Changes that are contemplated include: (a) Replacing the simulator used in the training process by a multiphase simulator, (b) Extending the parameter list for training scenarios (Table 1) to include two-phase parameters such as initial saturation and relative permeability, (c) Extending the definition of observation (Table 2) to include two-phase observations such as the saturation map, and/or (d) Extending the definition of reward to account for the potential production/injection of water/gas. For example, the DRL AI may be implemented for oil/water two-phase flow.

More Informative Observations: The observations as defined in Table 2 are mostly parameter groups directly in the governing equations. In some embodiments, the DRL AI can benefit from including derived observations that are more indicative of reservoir quality and connectivity. For example, the well potential measure map proposed by a previous work provides a metric that combines the static properties with dynamic flow diagnostic characteristics such as sweep efficiency. Such a metric has been shown to be indicative of good well locations. If included in the list observation, it could help make the policy and the value function more linear and simplify/accelerate the training of the value function network.

Human Performance Benchmark: In some embodiments herein, the performance of the AI was compared to reference agents that drill with fixed pattern regardless of the reservoir scenarios. The solutions from these reference agents do not necessarily look reasonable to human reservoir engineers. To establish the value of the AI, it is a common practice to establish a human performance baseline of the target task. This could be done by having human engineers manually design development plans for a set of synthetic scenarios and calculate the average performance.

It may be appealing to compare the AI to a black-box optimization algorithm such as the genetic algorithm; however, this may not be a fair comparison because the black-box algorithms require a large number of simulations/online runs to optimize a certain scenario while the AI, once trained, uses one simulation online. It also may not be a conclusive comparison because the performance of the genetic algorithm depends on the scenario and on how the problem is set up.

Other DRL Algorithms: In some embodiments herein, the PPO was used as the DRL algorithm. One limitation associated with PPO is that PPO is an online algorithm. As such, the simulation runs on the workers (in this case the CPUs) use the most current policy function. Therefore, when simulations are being run, the learner (in this case the GPUs) that updates the policy is idle, waiting for the workers to finish running the simulations. On the other hand, when the learner is updating the policy function, the workers are idle waiting for the policy function to be updated. The frequently alternating sessions of idling could lead to substantial losses in computational efficiency.

One possible candidate to resolve this efficiency issue is importance-weighted actor-learner architectures. In importance-weighted actor-learner architectures, the actors (on CPUs) will run the simulations in an asynchronized fashion and occasionally communicate the resulting policy to the learner (on GPU). The learner continuously updates the policy using the training samples from the actors, and occasionally communicates the current policy to the actors. The importance-weighted actor-learner architecture provides a theoretical formula to correct for the fact that the policy in actors is not necessarily the most up-to-date policy. It may eliminate the idling sessions and can substantially speed up the training.

Realism of the Training Set and Overfitting: In some embodiments herein, the reservoir area was generated by random ellipses. SGS was used to generate the porosity field with fixed variogram ranges and mean/standard deviation, and cloud transform was used to generate the permeability field based on the porosity field. As shown in FIG. 10, the models generated by this process may not resemble those upscaled from a real-life 3D reservoir. This gap between the training set and the target reservoir can lead to overfitting problems in which after a certain point in the training process, the performance of the DRL AI as tested on the target reservoir starts to decline when its performance on synthesized training scenarios is still improving.

There are two treatments for alleviating this overfitting problem. First, the diversity and realism of the training set need to be improved. Diversity can be improved by randomizing the variogram ranges and other statistical parameters to generate the field. Realism can be improved by incorporating real-life reservoir models. While these models are rare, they can be randomly perturbed and blended into the training set to avoid the AI being fixated on the synthesized training set. Second, overfitting may be alleviated by regularization, while in the loss formulation in Equation 11 there already are entropy loss and KL losses that regularize the optimization process. Additional regularization of the network using techniques such as dropouts or normalization could provide additional improvement.

Structure of the Network: Optimizing the design of the network in FIG. 3 could lead to improved performance for the DRL AI. Some of the straightforward hyperparameters to consider include the number of residual blocks, the number of filters at each level, the number of nodes on the embedding layers, etc.

In addition to the preceding hyperparameters, the structure of the network may also be improved. In the network structure in FIG. 3, the policy network (the network for action probability) and the value function network are independent, and they do not share weights. Theoretically, allowing the two networks to share weights on some or all the layers may accelerate convergence and improve regularization. One potential drawback is that when the two networks share weights, the relative weighting between the value network and the policy network (Equation 11) becomes important because the policy loss and the value function loss are now driving the same set of weights.

Hyperparameter Tuning and Sensitivity to Random Seed: In some embodiments herein, there are a large number of hyperparameters that could impact the performance of the DRL AI. For example, the set of weights cₖₗ, c_{vf}, and cₑₙₜ for the total loss function in Equation 11 substantially affects the convergence of the DRL AI. While it may be tempting to assign the weight such that the four terms in Equation 11 are balanced, in practice, this strategy is observed to lead to very slow convergence for the AI. Further investigation (e.g., through hyperparameter optimization) may be pursued to identify the optimal values for these parameters. As for the PPO clipping parameters ε, the default value of 0.3 appears to lead to good performance.

In addition, the hyperparameters for the SGD, such as the number of SGD iterations and the learning rate, could also affect the performance of the AI during training. Reducing the number of SGD iterations from 30 (the default value) to 5 achieved a 6× speedup without significant degradation of performance. In some embodiments, a fixed learning rate of 1×10⁻⁵ was used throughout the entire training process, but it is possible that by using a learning rate schedule (which starts with a large learning rate that gradually decreases) or by an adaptive learning rate scheme, the convergence of the AI can be further improved.

In addition to the hyperparameters, it is also observed that the performance of the DRL AI could depend on the random seed that is used to initialize the network. With the same configuration, a change in the random seed could result in a substantial difference in performance.

Extending to 3D: Some embodiments herein considered a 2D reservoir template, and 3D reservoir models were first upscaled to this template before applying the AI. In many real-life reservoirs, heterogeneities in the vertical direction have a strong impact on field development planning and can only be accurately modeled in 3D. There are two ways of extending the methodology to 3D. The first way is to consider a 3D model as a stack of 2D maps. The 2D convolution network may still be used to process.

The second way is to use a 3D CNN and 3D kernels. A 3D CNN is primarily used in spatial-temporal problems such as that of video analysis. Recently, it is also used in pure spatial problems such as seismic data processing.

It is noted that the approach to extend the AI to 3D, in which a 3D model is treated as a stack of 2D maps, has been successfully implemented.

Extending to Brownfield Problems: In some embodiments herein, greenfields were considered, that is, the environment is always initialized with zero wells. To train a DRL AI that can handle brownfield problems whereby there are preexisting wells (such as in the case of optimizing infill drilling), the initialization of well counts and reservoir state (such as pressure and saturation) can be randomized. This initialization can be accomplished by randomly selecting a well-placement agent and advancing the environment from the greenfield condition for a random number of steps. The definition of rewards may also be modified to reflect the incremental benefit of the new wells.

Handling of Faults: Some embodiments herein did not consider the impact of faulting on the FDP, which is an important feature for many reservoirs. If the faults are sealed (as a flow barrier) or just partially leaking, then they can be accounted for by modifying the porosity and transmissibility in the model. However, if the faults are highly permeable or if they have large throw (vertical displacement), they may result in nonneighboring cells being connected, and such nonneighbor connections cannot be represented in the formats of maps or 3D cubes. In those cases, techniques such as graph neural network, which allows for a connection-list type of representation of the reservoir, may be useful. Thus, at step 215 of the process 200, the policy neural network, the value neural network, or both may include a graph neural network to represent a fault (e.g., both the policy neural network may be a graph neural network and the value neural network may be a graph neural network in some embodiments, however only one of the policy neural network or the value neural network may be a graph neural network in some other embodiments). Step 215 of the process 200 may also include modifying a value of porosity, a value of transmissibility, or any combination thereof to represent a fault.

Handling of Horizontal Wells: Some embodiments herein considered only vertical wells in the FDP, and they are always assumed to have contact with the entire reservoir interval. It is possible to extend the DRL AI to consider horizontal wells, or more generally, slanted wells (in 3D) in the FDP. One way to do it is to represent the action of drilling a horizontal well as two consecutive actions of determining the locations of the heels and the toe. However, this representation could exponentially increase the size of the action space. For example, on a 50×40 reservoir template with no inactive cells, the number of possible actions for drilling a vertical well is 2,001, while the number of possible actions for drilling a horizontal well is 2,000×1,999+1=3,998,001. Such a large number of possible actions present a challenge even for the state-of-the-art DRL algorithms. Another way to represent a horizontal well is by the location of its middle point, the angle, and the length. By controlling the discretization level of the angle and the length, the number of possible actions can be substantially reduced. Thus, at step 215 of the process 200, the field development action may include drilling a horizontal well as two consecutive actions. The two consecutive actions include determining a location of a heel of the horizontal well and determining a location of a toe of the horizontal well. Additionally, at step 215 of the process 200, the field development action may include drilling a horizontal well by location of its middle point, angle, and length.

Extending to Larger-Size Reservoir Template: In some embodiments herein, the DRL AI is trained for a rather specific setting (fixed reservoir template, fixed description of observations, etc.). Any change to this setting may require retraining the DRL AI. For example, if a DRL AI for a 40×40 reservoir template is available and it is to be extended to a reservoir template of 50×50, the AI may need to be retrained from scratch. One possible way to avoid the high computational cost of retraining from scratch is by the use of transfer RL. In transfer RL, the AI is first trained on source tasks. Then a part of the trained neural network is frozen (i.e., weights are fixed) and combined with new layers. This new neural network is then trained on the target task. Because most of the weights in the network are fixed, the size of the optimization problem is much smaller, and the computational cost for the training on the target task is much lower. For example, in a previous work, an AI for playing games was first trained on a number of different games. Then, transfer RL was used to adapt the AI to games that it has not encountered before. It is shown that the training process for the new games can be substantially accelerated. Thus, step 220 of the process 200 may include applying transfer reinforcement learning to speed up the training of the policy neural network and the value neural network.

Extending to Optimization under Uncertainty: In some embodiments herein, one optimal FDP was designed for one deterministic model. In practice, there is a substantial number of uncertainties in subsurface models, which is usually characterized by multiple model realizations. An FDP may be much more reliable when it is optimized over these multiple realizations (this is also called robust optimization). It is possible to train a DRL AI that provides an FDP that is optimal under uncertainty. One way to do that is to include all realizations of the models as parts of the state, simulate the effect of AI action on all model realizations simultaneously, and use the weighted average reward over all the model realizations as the reward for the AI. The drawback of this approach is that it may substantially increase the number of input channels of the neural network, and thus the computational cost.

Incorporating Value of Information: In some embodiments herein, the NPV is taken as the objective function, and while this is a common practice in optimization studies, it does ignore the fact that there will be information that comes during the development of each well that could change the development plan. The value of information from some well locations (e.g., a pilot well in a highly uncertain area) may make them preferable to others with higher NPV. One way to address this is to incorporate an estimate of the value of information (e.g., using the amount of uncertainty in connectivity as a proxy) into the objective function. An AI trained using such an objective function should be able to consider value of information from piloting wells when optimizing the development plan.

As provided hereinabove, DRL has been applied for generalizable field development optimization, whereby the goal was to train an AI to provide the optimal solution for new and unseen scenarios (different reservoir models, different price assumption, etc.) with minimal computational cost. This is fundamentally different from traditional scenario-specific field development optimization, whereby the solution is a plan tied to a specific scenario, and optimization needs to be rerun whenever the scenario changes. This is also different from optimization under uncertainty (also known as robust optimization), which is still scenario specific because the solution is tied to a specific description of uncertainty.

Some embodiments provided hereinabove formulated the generalizable field development optimization problem as an MDP in which the environment is represented by the reservoir simulator, the action is the next drilling location, and the reward is the NPV. At every decision step, the AI agent makes an observation of the environment state and projects it through a policy function to the optimal action for this decision step. The environment simulates the action and advances its state to the next timestep. The policy function is modeled as a deep neural network that is trained on millions of simulations to maximize the total expected rewards (expected NPV) of the AI through the PPO method.

The methodology is applied to generalizable field development optimization of greenfield primary depletion problems. It is shown that in starting from no reservoir engineering knowledge, the AI can learn basic reservoir engineering principles, such as placing wells at favorable locations with high porosity and permeability, choosing a reasonable number of wells, and maintaining good well spacing. The resulted AI also statistically outperformed reference strategies that drill wells in patterns. An example was provided herein that showed how the resulted AI has been used to obtain FDPs for a real field that is better than the one initially designed by human engineers.

Finally, potential ways to further improve the AI applicability and performance have been discussed in detail hereinabove.

The methods and systems of the present disclosure may be implemented by a system and/or in a system, such as a system 1610 shown in FIG. 16. The system 1610 may include one or more of a processor 1611, an interface 1612 (e.g., bus, wireless interface), an electronic storage 1613, a graphical display 1612, and/or other components. The processor 1611 may be utilized to generate a field development plan for a hydrocarbon field development, including training (e.g., training a policy neural network and a value neural network using deep reinforcement learning on a plurality of training reservoir models with a reservoir simulator as an environment such that the policy neural network generates a field development plan comprising well counts, well locations, well type, well sequence, or any combination thereof to improve profitability of a hydrocarbon field development) and application (e.g., generating a field development plan for the target reservoir on the reservoir template with the rescaled and normalized target input values, the trained policy network, and the reservoir simulator).

The electronic storage 1613 may be configured to include electronic storage medium that electronically stores information. The electronic storage 1613 may store software algorithms, information determined by the processor 1611, information received remotely, and/or other information that enables the system 1610 to function properly. For example, the electronic storage 1613 may store information relating to the plurality of training reservoir models of varying values of input channels of a reservoir template (e.g., the input channels represent geological properties, rock-fluid properties, operational constraints, economic conditions, or any combination thereof), the trained policy neural network, the PPO, the field development plan (e.g. the field development plan may include well counts, well locations, well type, well sequence, or any combination thereof to improve profitability of a hydrocarbon field development), the values for the input channels according to the reservoir template for a target reservoir, the rescaled and normalized target input values, the final field development plan for the target reservoir, the one or more digital images that the final field development plan is output to, and/or other information. The electronic storage media of the electronic storage 1613 may be provided integrally (i.e., substantially non-removable) with one or more components of the system 1610 and/or as removable storage that is connectable to one or more components of the system 1610 via, for example, a port (e.g., a USB port, a Firewire port, etc.) or a drive (e.g., a disk drive, etc.). The electronic storage 1613 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 1613 may be a separate component within the system 1610, or the electronic storage 1613 may be provided integrally with one or more other components of the system 1610 (e.g., the processor 1611). Although the electronic storage 1613 is shown in FIG. 16 as a single entity, this is for illustrative purposes only. In some implementations, the electronic storage 1613 may comprise a plurality of storage units. These storage units may be physically located within the same device, or the electronic storage 1613 may represent storage functionality of a plurality of devices operating in coordination.

The graphical display 1614 may refer to an electronic device that provides visual presentation of information. The graphical display 1614 may include a color display and/or a non-color display. The graphical display 1614 may be configured to visually present information. The graphical display 1614 may present information using/within one or more graphical user interfaces. For example, the graphical display 1614 may present information relating to at least one portion of the final field development plan that is output to one or more digital images, and/or other information.

The processor 1611 may be configured to provide information processing capabilities in the system 1610. As such, the processor 1611 may comprise one or more of a digital processor, a physical processor, an analog processor, a digital circuit designed to process information, a central processing unit, a graphics processing unit, a microcontroller, an analog circuit designed to process information, a state machine, and/or other mechanisms for electronically processing information. The processor 1611 may be configured to execute one or more machine-readable instructions 16100 to facilitate generation of the field development plans for the hydrocarbon field development. The machine-readable instructions 16100 may include one or more computer program components. The machine-readable instructions 16100 may include a reservoir template component 16102, a normalization component 16104, a neural network construction component 16106, a deep reinforcement learning component 16108, a target reservoir component 16110, and/or other computer program components.

It should be appreciated that although computer program components are illustrated in FIG. 16 as being co-located within a single processing unit, one or more of computer program components may be located remotely from the other computer program components. While computer program components are described as performing or being configured to perform operations, computer program components may comprise instructions which may program processor 1611 and/or system 1610 to perform the operation.

While computer program components are described herein as being implemented via processor 1611 through machine-readable instructions 16100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 16100, the reservoir template component 16102 may be configured to generate the plurality of training reservoir models of varying values of input channels of the reservoir template. The input channels represent geological properties, rock-fluid properties, operational constraints, economic conditions, or any combination thereof. More information is provided hereinabove in connection with step 205 of process 200 in FIG. 2A.

The normalization component 16104 may be configured to normalize the varying values of the input channels to generate normalized values of the input channels. More information is provided hereinabove in connection with step 210 of process 200 in FIG. 2A.

The neural network construction component 16106 may be configured to construct the policy neural network and the value neural network that project the state represented by the normalized values of the input channels to the field development action and the value of the state respectively. More information is provided hereinabove in connection with step 215 of process 200 in FIG. 2A.

The deep reinforcement learning (DRL) component 16108 may be configured to train the policy neural network and the value neural network using deep reinforcement learning on the plurality of training reservoir models with the reservoir simulator as the environment such that the policy neural network generates the field development plan comprising well counts, well locations, well type, well sequence, or any combination thereof to improve profitability of the hydrocarbon field development. More information is provided hereinabove in connection with step 220 of process 200 in FIG. 2A.

The target reservoir component 16110 may be configured to obtain values for the input channels according to the reservoir template for a target reservoir; rescale and normalize the obtained values for the input channels to generate rescaled and normalized target input values; generate a field development plan for the target reservoir on the reservoir template with the rescaled and normalized target input values, the trained policy network, and the reservoir simulator; rescale the generated field development plan to scale of the target reservoir model to generate a final field development plan for the target reservoir; and output, on a graphical user interface, at least a portion of the final field development plan. More information is provided hereinabove in connection with step 230 of process 200 in FIG. 2A and step 255 of process 250 in FIG. 2B. Of note, in some embodiments, different components may be configured to perform some of these steps instead of the target reservoir component 16110. For example, a separate output component may even be utilized for outputting, on a graphical user interface, at least a portion of the final field development plan and/or where the at least one portion of the final field development plan is output to one or more digital images.

The comparison component 16112 may be configured to compare the final field development plan for the target reservoir against at least one other field development plan for the target reservoir, wherein the at least one other field development plan is generated by a human, by an optimization algorithm, or any combination thereof. More information is provided hereinabove in connection with step 235 of process 200 in FIG. 2A and step 260 of process 250 in FIG. 2B.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein. More information may be found at Jincong He et al. Deep Reinforcement Learning for Generalizable Field Development Optimization. SPE Journal. SPE 203951. Jul. 12, 2021, which is incorporated by reference.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The term “obtaining” may include receiving, retrieving, accessing, generating, etc. or any other manner of obtaining data.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of generating a field development plan for a hydrocarbon field development, the method comprising:
generating a plurality of training reservoir models of varying values of input channels of a reservoir template, wherein the input channels represent geological properties, rock-fluid properties, operational constraints, economic conditions, or any combination thereof;
normalizing the varying values of the input channels to generate normalized values of the input channels;
constructing a policy neural network and a value neural network that project a state represented by the normalized values of the input channels to a field development action and a value of the state respectively; and
training the policy neural network and the value neural network using deep reinforcement learning on the plurality of training reservoir models with a reservoir simulator as an environment such that the policy neural network generates a field development plan comprising well counts, well locations, well type, well sequence, or any combination thereof to improve profitability of a hydrocarbon field development.

2. The method of claim 1, wherein at least one two dimensional (2D) digital image is utilized to represent the values after normalization of each input channel.

3. The method of claim 1, wherein at least one three dimensional (3D) digital cube is utilized to represent the values after normalization of each input channel.

4. The method of claim 1, wherein at least portions of the policy neural network and the value neural network comprise convolution layers and residual blocks.

5. The method of claim 1, wherein the deep reinforcement learning comprises proximal policy optimization (PPO), Importance weighted Actor-Learner Architecture (IMPALA), or any combination thereof.

6. The method of claim 1, wherein the deep reinforcement learning comprises proximal policy optimization (PPO) having a weighted combination of four components, wherein the four components are (A) a policy loss L^{π}, (B) KL divergence penalty L^{kl}, (C) a value function loss L^{vf}, and (D) an entropy penalty L^{ent}, and wherein the four components are expressed in an equation:
L^{PPO}=L^{π}+cₖₗL^{kl}+c_{vf}L^{vf}+cₑₙₜL^{ent}
wherein cₖₗ, c_{vf}, and cₑₙₜ are weights for each individual loss component.

7. The method of claim 1, further comprising using a stochastic gradient descent (SGD) algorithm during the training.

8. The method of claim 1, wherein the policy neural network and the value neural network share weights in at least one layer.

9. The method of claim 1, wherein the policy neural network and the value neural network do not share weights.

10. The method of claim 1, wherein the policy neural network and the value neural network comprise an action embedding layer to force the policy network to learn low dimensional representations of actions during the training.

11. The method of claim 1, further comprising applying action masking to invalidate at least one user-defined invalid action during the training.

12. The method of claim 1, further comprising modifying a value of porosity, a value of transmissibility, or any combination thereof to represent a fault.

13. The method of claim 1, wherein the policy neural network, the value neural network, or both comprise a graph neural network to represent a fault.

14. The method of claim 1, wherein the field development action comprises drilling a horizontal well as two consecutive actions, wherein the two consecutive actions comprise determining a location of a heel of the horizontal well and determining a location of a toe of the horizontal well.

15. The method of claim 1, wherein the field development action comprises drilling a horizontal well by location of its middle point, angle, and length.

16. The method of claim 1, further comprising applying transfer reinforcement learning to speed up the training of the policy neural network and the value neural network.

17. The method of claim 1, wherein at least one input channel of the reservoir template represents a plurality of properties.

18. The method of claim 1, further comprising:
obtaining values for the input channels according to the reservoir template for a target reservoir;
rescaling and normalizing the obtained values for the input channels to generate rescaled and normalized target input values;
generating a field development plan for the target reservoir on the reservoir template with the rescaled and normalized target input values, the trained policy network, and the reservoir simulator;
rescaling the generated field development plan to scale of the target reservoir model to generate a final field development plan for the target reservoir; and
outputting, on a graphical user interface, at least a portion of the final field development plan.

19. A system of generating a field development plan for a hydrocarbon field development, the system comprising:
one or more physical processors configured by machine-readable instructions to:
generate a plurality of training reservoir models of varying values of input channels of a reservoir template, wherein the input channels represent geological properties, rock-fluid properties, operational constraints, economic conditions, or any combination thereof;
normalize the varying values of the input channels to generate normalized values of the input channels;
construct a policy neural network and a value neural network that project a state represented by the normalized values of the input channels to a field development action and a value of the state respectively; and
train the policy neural network and the value neural network using deep reinforcement learning on the plurality of training reservoir models with a reservoir simulator as an environment such that the policy neural network generates a field development plan comprising well counts, well locations, well type, well sequence, or any combination thereof to improve profitability of a hydrocarbon field development.

20. The system of claim 19, wherein the one or more physical processors are further configured by machine-learning instructions to:
obtain values for the input channels according to the reservoir template for a target reservoir;
rescale and normalize the obtained values for the input channels to generate rescaled and normalized target input values;
generate a field development plan for the target reservoir on the reservoir template with the rescaled and normalized target input values, the trained policy network, and the reservoir simulator;
rescale the generated field development plan to scale of the target reservoir model to generate a final field development plan for the target reservoir; and
output, on a graphical user interface, at least a portion of the final field development plan.

21. A method of generating a field development plan for a hydrocarbon field development, the method comprising:
obtaining values for input channels according to a reservoir template for a target reservoir, wherein the input channels represent geological properties, rock-fluid properties, operational constraints, economic conditions, or any combination thereof;
rescaling and normalizing the obtained values for the input channels to generate rescaled and normalized target input values;
generating a field development plan for the target reservoir on the reservoir template with the rescaled and normalized target input values, a trained policy network, and a reservoir simulator;
rescaling the generated field development plan to scale of the target reservoir model to generate a final field development plan for the target reservoir; and
outputting, on a graphical user interface, at least a portion of the final field development plan.

22. The method of claim 21, wherein the at least one portion of the final field development plan is output to one or more digital images.

23. The method of claim 21, further comprising applying action masking to invalidate at least one user-defined invalid action during generating the field development plan for the target reservoir.

24. The method of claim 21, further comprising comparing the final field development plan for the target reservoir against at least one other field development plan for the target reservoir, wherein the at least one other field development plan is generated by a human, by an optimization algorithm, or any combination thereof.

25. The method of claim 21, wherein the trained policy network was trained using deep reinforcement learning on a plurality of training reservoir models with the reservoir simulator as an environment such that the policy neural network generates a field development plan comprising well counts, well locations, well type, well sequence, or any combination thereof to improve profitability of a hydrocarbon field development, and wherein the plurality of training reservoir models of varying values of input channels of a reservoir template were generated, and wherein the varying values of the input channels were normalized to generate normalized values of the input channels, and wherein the policy neural network and a value neural network were constructed that project a state represented by the normalized values of the input channels to a field development action and a value of the state respectively.

26. A system of generating a field development plan for a hydrocarbon field development, the system comprising:
one or more physical processors configured by machine-readable instructions to:
obtain values for input channels according to a reservoir template for a target reservoir, wherein the input channels represent geological properties, rock-fluid properties, operational constraints, economic conditions, or any combination thereof;
rescale and normalize the obtained values for the input channels to generate rescaled and normalized target input values;
generate a field development plan for the target reservoir on the reservoir template with the rescaled and normalized target input values, a trained policy network, and a reservoir simulator;
rescale the generated field development plan to scale of the target reservoir model to generate a final field development plan for the target reservoir; and
outputting, on a graphical user interface, at least a portion of the final field development plan.
